(19) United States
(12) Patent Application Publication
(10) Pub. No.: US 2014/0058833 A1
(43) Pub. Date: Feb. 27, 2014

(54) Commerce System and Method of Controlling the Commerce System Using Bidding and Value Based Messaging

(71) Applicants: Kenneth J. Ouimet, Davis, CA (US); Wayne C. Neale, Phoenix, AZ (US)

(72) Inventors: Kenneth J. Ouimet, Davis, CA (US); Wayne C. Neale, Phoenix, AZ (US)

(73) Assignee: MYWORLD, INC., Scottsdale, AZ (US)

(21) Appl. No.: 13/591,710

(22) Filed: Aug. 22, 2012

(51) Int. Cl. G06Q 30/02

(52) U.S. Cl. 705/14.49

(57) ABSTRACT

A commerce system has retailers offering products for sale to consumers. A plurality of bids for a search criteria are accepted. A winning bid for the search criteria is selected from the plurality of bids. Value message content related to the winning bid for the search criteria is accepted. An interface to submit a search query corresponding to the search criteria is provided. Search results corresponding to the search query are collected. The commerce system is controlled by displaying the search results and value message content to influence purchasing decisions. A market segment is applied to a scope of the bids. The search criteria is accepted with the bids. The winning bid is selected based on a value of the bids. A database containing product information is provided. The search results corresponding to the search query are collected from the database.

### FIELD OF THE INVENTION

The present invention relates in general to consumer purchasing and, more particularly, to a commerce system and method of controlling the commerce system by accepting bids and presenting value messages to consumers.

### BACKGROUND OF THE INVENTION

Business planning is commonly used in commercial ventures. In the retail environment, grocery stores, general merchandise stores, specialty shops, and other retail outlets face stiff competition for limited consumers and business. In the face of mounting competition and high expectations from investors, retailers must look for every advantage they can muster in maximizing market share, sales, revenue, and profit. The retailer operates under a business plan to set pricing, order inventory, formulate and run promotions, add and remove product lines, organize product shelving and displays, select signage, hire employees, expand stores, collect and maintain historical sales data, evaluate performance and trends, and make strategic decisions. The retailer can change the business plan as needed.

A consumer-minded retailer should understand that while the consumer may state that price is important to the purchasing decision, there are other factors that influence consumer loyalty and selection of a preferred retailer. In addition to price, consumers choose a retailer based on service, convenience, product arrangement and availability, quality of product, hours of operation, length of lines at checkout, cleanliness of premises, safety, and overall perception of the shopping experience. Consumer preferences are a material factor.

For example, a consumer shopping for Product X presents an opportunity for competing Product Y to convert a customer. To entice a positive purchasing decision from the consumer, there must be some reason or motivation. Product Y seeks to provide motivation by creating the perception of value in the mind of the consumer. One challenge facing Product Y is finding a cost-effective strategy to present value to the consumer interested in competing products.

Retailers struggle to present products to consumers in a manner that conveys value in terms of the factors discussed above. Traditional marketing techniques often fail to reach consumers, who regularly ignore or filter out most product advertisements. For example, consumers regularly throw away mailed advertisements before reading the content, automatically categorizing all mail based marketing material as junk mail. Many email systems filter marketing messages out of email inboxes before consumers know the messages exist. Filtered messages are labeled as spam and rarely viewed. A retailer might offer a product that would best suit the needs of a particular consumer but cannot present the value of the product to the consumer through a cost-effective avenue. Reaching a captive consumer audience remains extremely difficult and expensive for retailers.

In a highly competitive market, the profit margin is paper thin and consumers and products are becoming more differentiated. Consumers will often have appetites only for specific products. Retailers must understand and act upon the market segment that is tuned into their niche product area to make effective use of marketing dollars. The traditional mass marketing approach using gross market segmentation cannot effectively target consumers in specific market segments. The cost of the traditional techniques often does not justify the marginal sales generated by the techniques. Retailers remain motivated to improve marketing systems and develop cost-effective means of creating the perception of value in the minds of the consumers.

### SUMMARY OF THE INVENTION

A need exists for retailers to create the perception of value in the minds of consumers using cost-effective systems. Accordingly, in one embodiment, the present invention is a method of controlling a commerce system comprising the steps of accepting a plurality of bids for a search criteria, selecting a winning bid for the search criteria from the plurality of bids, accepting value message content related to the winning bid for the search criteria, providing an interface to submit a search query corresponding to the search criteria, collecting search results corresponding to the search query, and controlling the commerce system by displaying the search results and value message content to influence purchasing decisions.

In another embodiment, the present invention is a method of controlling a commerce system comprising the steps of accepting a plurality of bids for a search criteria, selecting a winning bid for the search criteria from the plurality of bids, accepting value message content related to the winning bid for the search criteria, receiving a search query corresponding to the search criteria, and displaying the value message content.

In another embodiment, the present invention is a method of controlling a commerce system comprising the steps of accepting a bid for a search criteria, receiving a search query corresponding to the search criteria, and displaying content related to the bid for the search criteria.

In another embodiment, the present invention is a computer program product usable with a programmable computer processor having a computer readable program code embodied in a non-transitory computer usable medium for controlling a commerce system comprising the steps of accepting a bid for a search criteria, receiving a search query corresponding to the search criteria, and displaying content related to the bid for the search criteria.

### BRIEF DESCRIPTION OF THE DRAWINGS

FIG. 1 illustrates a retailer engaged in commercial activity with a consumer;

FIG. 2 illustrates a commercial system with a manufacturer, distributor, retailer, and consumer;

FIG. 3 illustrates commercial transactions between consumers and retailers with the aid of a consumer service provider;

FIG. 4 illustrates an electronic communication network between members of the commerce system;

FIG. 5 illustrates a computer system operating with the electronic communication network;

FIG. 6 illustrates a consumer profile registration webpage with the consumer service provider;

FIG. 7 illustrates a login webpage for the consumer service provider;

FIG. 8 illustrates commercial interaction between the consumers, retailers, and consumer service provider to generate organic search results and value messages;

FIG. 9 illustrates collecting product information from retailer websites directly by the consumer service provider or indirectly using consumer computers;

FIG. 10 illustrates a plurality of products organized into a product family;

FIG. 11 illustrates a product family for yogurt products having similar attributes;

FIG. 12 illustrates a product family for rice products having similar attributes;

FIG. 13 illustrates a product family for paper towel products having similar attributes;

FIG. 14 illustrates a product family for liquid laundry detergent products having similar attributes;

FIG. 15 illustrates a home webpage for the consumer when communicating with the consumer service provider;

FIG. 16 illustrates a search webpage for the consumer to locate preferred retailers on a map;

FIG. 17 illustrates a plurality of links to consumer shopping lists;

FIG. 18 illustrates a webpage for the consumer to select product categories when creating or modifying the shopping list;

FIG. 19 illustrates a dairy products webpage for the consumer to select product attributes and assign weighting factors;

FIG. 20 illustrates a breakfast cereal webpage for the consumer to select product attributes and assign weighting factors;

FIG. 21 illustrates a cell phone for the consumer to select product attributes and assign weighting factors;

FIG. 22 illustrates creating a shopping list from the consumer-defined product attributes and weighting factors and product information stored in a database;

FIG. 23 illustrates a retailer interacting with consumers to provide value messages;

FIG. 24 illustrates a retailer profile registration webpage with the consumer service provider;

FIG. 25 illustrates commercial interaction between the consumers, retailers, and consumer service provider to collect bids and value messages to present to consumers;

FIGS. 26a-26b illustrate a campaign table completed by a retailer to submit bids and value messages to consumer service provider;

FIG. 27 illustrates a search interface for retailers to interact with consumer service provider;

FIGS. 28a-28e illustrate an interface for consumers to view search results and value messages;

FIG. 29 illustrates a consumer interface for viewing value messages and offers; and

FIG. 30 illustrates the process of controlling purchasing decisions within the commerce system by enabling the consumer to identify products of value for purchase.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

In the face of mounting competition and high expectations from investors a business must look for every possible advantage in maximizing market share and profits. The ability to consider factors which materially affect overall revenue and profitability and adjust the business plan accordingly is vital to the success of the bottom line, and the fundamental need to not only survive but to prosper and grow.

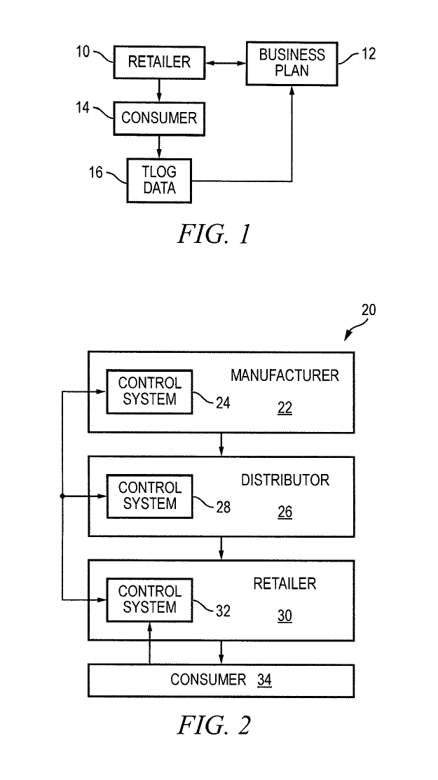

Referring to FIG. 1, retailer 10 has certain product lines or services available to consumers as part of its business plan 12. The terms products and services are interchangeable in the commercial system. Retailer 10 can be a food store, general consumer product retailer, drug store, discount warehouse, department store, apparel store, specialty store, or service provider. Retailer 10 operates under business plan 12 to set pricing, order inventory, formulate and run promotions, add and remove product lines, organize product shelving and displays, select signage, hire employees, expand stores, collect and maintain historical sales data, evaluate performance and trends, and make strategic decisions. Retailer 10 can change business plan 12 as needed. While the present discussion will involve a retailer, it is understood that the system described herein is applicable to other members in the chain of commerce, or other industries and businesses having similar goals, constraints, and needs.

Retailer 10 routinely enters into sales transactions with customer or consumer 14. In fact, retailer 10 maintains and updates its business plan 12 to increase the number of transactions (and thus revenue and/or profit) between retailer 10 and consumer 14. Consumer 14 can be a specific individual, account, or business entity.

For each sale transaction entered into between retailer 10 and consumer 14, information is stored in transaction log (T-LOG) data 16. When a consumer goes through the checkout at a grocery store or any other retail store, each of the items to be purchased is scanned and data is collected and stored by a point-of-sale (POS) system, or other suitable data collection system, in T-LOG data 16. The data includes the then current price, promotion, and merchandizing information associated with the product along with the units purchased, and the dollar sales. The time, date, store, and consumer information corresponding to that purchase are also recorded.

T-LOG data 16 contains one or more line items for each retail transaction, such as those shown in Table 1. Each line item includes information or attributes relating to the transaction, such as store number, product number, time of transaction, transaction number, quantity, current price, profit, promotion number, and consumer identity or type number. The store number identifies a specific store; product number identifies a product; time of transaction includes date and time of day; quantity is the number of units of the product; current price (in US dollars) can be the regular price, reduced price, or higher price in some circumstances; profit is the difference between current price and cost of selling the item; promotion number identifies any promotion associated with the product, e.g., flyer, ad, discounted offer, sale price, coupon, rebate, end-cap, etc.; consumer identifies the consumer by type, class, region, demographics, or individual, e.g., discount card holder, government sponsored or under-privileged, volume purchaser, corporate entity, preferred consumer, or special member. T-LOG data 16 is accurate, observable, and granular product information based on actual retail transactions within the store. T-LOG data 16 represents the known and observable results from the consumer buying decision or process. T-LOG data 16 may contain thousands of transactions for retailer 10 per store per day, or millions of transactions per chain of stores per day.

TABLE 1
T-LOG Data

| STORE | PRODUCT | TIME | TRANS | QTY | PRICE | PROFIT | PROMOTION | CONSUMER |
|---|---|---|---|---|---|---|---|---|
| S1 | P1 | D1 | T1 | 1 | 1.50 | 0.20 | PROMO1 | C1 |
| S1 | P2 | D1 | T1 | 2 | 0.60 | 0.05 | PROMO2 | C1 |
| S1 | P3 | D1 | T1 | 3 | 3.00 | 0.40 | PROMO3 | C1 |
| S1 | P4 | D1 | T2 | 4 | 1.60 | 0.50 | 0 | C2 |
| S1 | P5 | D1 | T2 | 1 | 2.25 | 0.60 | 0 | C2 |
| S1 | P6 | D1 | T3 | 10 | 2.65 | 0.55 | PROMO4 | C3 |
| S1 | P1 | D2 | T4 | 5 | 1.50 | 0.20 | PROMO1 | C4 |
| S2 | P7 | D3 | T5 | 1 | 5.00 | 1.10 | PROMO5 | C5 |
| S2 | P1 | D3 | T6 | 2 | 1.50 | 0.20 | PROMO1 | C6 |
| S2 | P8 | D3 | T6 | 1 | 3.30 | 0.65 | 0 | C6 |

The first line item shows that on day/time D1, store S1 has transaction T1 in which consumer C1 purchases one product P1 at $1.50. The next two line items also refer to transaction T1 and day/time D1, in which consumer C1 also purchases two products P2 at $0.60 each and three products P3 at price $3.00 each. In transaction T2 on day/time D1, consumer C2 has four products P4 at price $1.60 each and one product P5 at price $2.25. In transaction T3 on day/time D1, consumer C3 has ten products P6 at $2.65 each in his or her basket. In transaction T4 on day/time D2 (different day and time) in store S1, consumer C4 purchases five products P1 at price $1.50 each. In store S2, transaction T5 with consumer C5 on day/time D3 (different day and time) involves one product P7 at price $5.00. In store S2, transaction T6 with consumer C6 on day/time D3 involves two products P1 at price $1.50 each and one product P8 at price $3.30.

Table 1 further shows that product P1 in transaction T1 has promotion PROMO1. PROMO1 can be any suitable product promotion such as a front-page featured item in a local advertising flyer. Product P2 in transaction T1 has promotion PROMO2 as an end-cap display in store S1. Product P3 in transaction T1 has promotion PROMO3 as a reduced sale price with a discounted offer. Product P4 in transaction T2 on day/time D1 has no promotional offering. Likewise, product P5 in transaction T2 has no promotional offering. Product P6 in transaction T3 on day/time D1 has promotion PROMO4 as a volume discount for 10 or more items. Product P7 in transaction T5 on day/time D3 has promotion PROMO5 as a $0.50 rebate. Product P8 in transaction T6 has no promotional offering. A promotion may also be classified as a combination of promotions, e.g., flyer with sale price, end-cap with rebate, or individualized discounted offer as described below.

Retailer 10 may also provide additional information to T-LOG data 16 such as promotional calendar and events, holidays, seasonality, store set-up, shelf location, end-cap displays, flyers, and advertisements. The information associated with a flyer distribution, e.g., publication medium, run dates, distribution, product location within flyer, and advertised prices, is stored within T-LOG data 16.

In FIG. 2, a commerce system 20 is shown involving the movement of goods between members of the system. Manufacturer 22 produces goods in commerce system 20. Manufacturer 22 uses control system 24 to receive orders, control manufacturing and inventory, and schedule deliveries. Distributor 26 receives goods from manufacturer 22 for distribution within commerce system 20. Distributor 26 uses control system 28 to receive orders, control inventory, and schedule deliveries. Retailer 30 receives goods from distributor 26 for sale within commerce system 20. Retailer 30 uses control system 32 to place orders, control inventory, and schedule deliveries with distributor 26. Retailer 30 sells goods to consumer 34. Consumer 34 patronizes retailer's establishment either in person or by using online ordering. The consumer purchases are entered into control system 32 of retailer 30 as T-LOG data 16.

The purchasing decisions made by consumer 34 drive the manufacturing, distribution, and retail portions of commerce system 20. More purchasing decisions made by consumer 34 for retailer 30 lead to more merchandise movement for all members of commerce system 20. Manufacturer 22, distributor 26, and retailer 30 utilize respective control systems 24, 28, and 32, to control and optimize the ordering, manufacturing, distribution, sale of the goods, and otherwise execute respective business plan 12 within commerce system 20 in accordance with the purchasing decisions made by consumer 34.

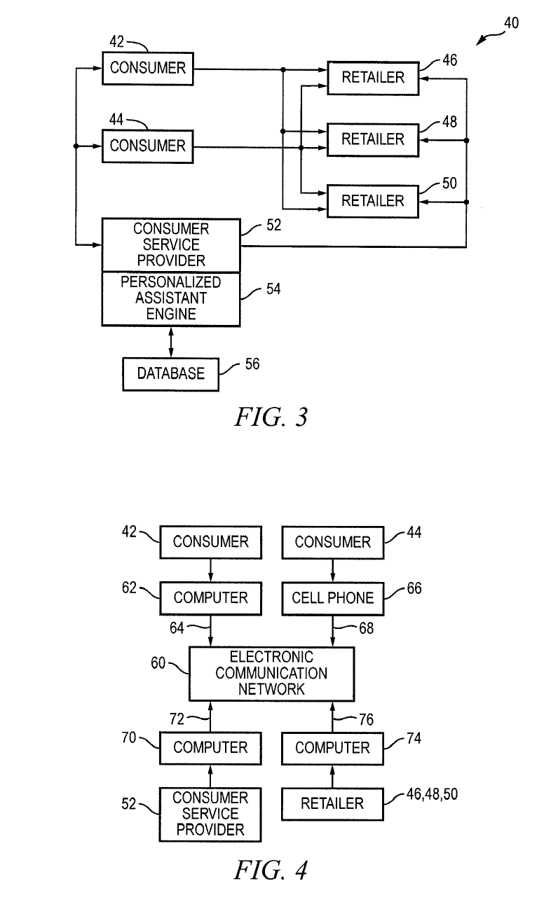

FIG. 3 illustrates a commerce system 40 with consumers 42 and 44 engaged in purchasing transactions with retailers 46, 48, and 50. Retailers 46-50 are supplied by manufacturers and distributors, as described in FIG. 2. Retailers 46-50 are typically local to consumers 42-44, i.e., retailers that the consumers will likely patronize. Retailers 46-50 can also be remote from consumers 42-44 with transactions handled by electronic communication medium, e.g., phone or online website via personal computer, and delivered electronically or by common carrier, depending on the nature of the goods. Consumers 42-44 patronize retailers 46-50 to select one or more items for purchase. For example, consumer 42 can visit the store of retailer 46 in person and select product P1 for purchase. Consumer 42 can contact retailer 48 by phone or email and select product P2 for purchase. Consumer 44 can browse the website of retailer 50 using a personal computer and select product P3 for purchase. Accordingly, consumers 42-44 and retailers 46-50 regularly engage in commercial transactions within commerce system 40.

As described herein, manufacturer 22, distributor 26, retailers 46-50, consumers 42-44, and consumer service provider 52 are considered members of commerce system 40. The retailer generally refers to the seller of the product and consumer generally refers to the buyer of the product. Depending on the transaction within commerce system 40, manufacturer 22 can be the seller and distributor 26 can be the buyer, or distributor 26 can be the seller and retailers 46-50 can be the buyer, or manufacturer 22 can be the seller and consumers 42-44 can be the buyer.

A consumer service provider 52 is a part of commerce system 40. Consumer service provider 52 is a third party that assists consumers 42-44 with the product evaluation and purchasing decision process by providing access to a comparative shopping service. More specifically, consumer service provider 52 operates and maintains personal assistant engine 54 that provides a searchable product database and shopping list service using consumer-weighted preferences. The product attributes and consumer-weighted preferences are stored in database 56. Consumers 42-44 can submit search queries to consumer service provider 52, which returns a set of search results corresponding to the search criteria.

Personal assistant engine 54 can be made available to consumers 42-44 via computer-based online website or other electronic communication medium, e.g., wireless cell phone or other personal communication device. FIG. 4 shows an electronic communication network 60 for transmitting information between consumers 42-44, consumer service provider 52, and retailers 46-50. Consumer 42 operating with computer 62 is connected to electronic communication network 60 by way of communication channel or link 64. Likewise, consumer 44 operating with a cellular telephone, smart phone, or other wireless communication device 66 is connected to electronic communication network 60 by way of communication channel or link 68. Consumer service provider 52 uses computer 70 to communicate with electronic communication network 60 over communication channel or link 72. Retailers 46, 48, and 50 use computer 74 to communicate with electronic communication network 60 over communication channel or link 76. The electronic communication network 60 is a distributed network of interconnected routers, gateways, switches, and servers, each with a unique internet protocol (IP) address to enable communication between individual computers, cellular telephones, electronic devices, or nodes within the network. In one embodiment, electronic communication network 60 is a cell phone service network. Alternatively, communication network 60 is a global, open-architecture network, commonly known as the Internet. Communication channels 64, 68, 72, and 76 are bi-directional and transmit data between computers 62, 70, and 74 and cell phone 66 and electronic communication network 60 in a hard-wired or wireless configuration. For example, computers 62, 70, and 74 have email, texting, and Internet capability, and consumer cell phone 66 has email, mobile applications (apps), texting, and Internet capability.

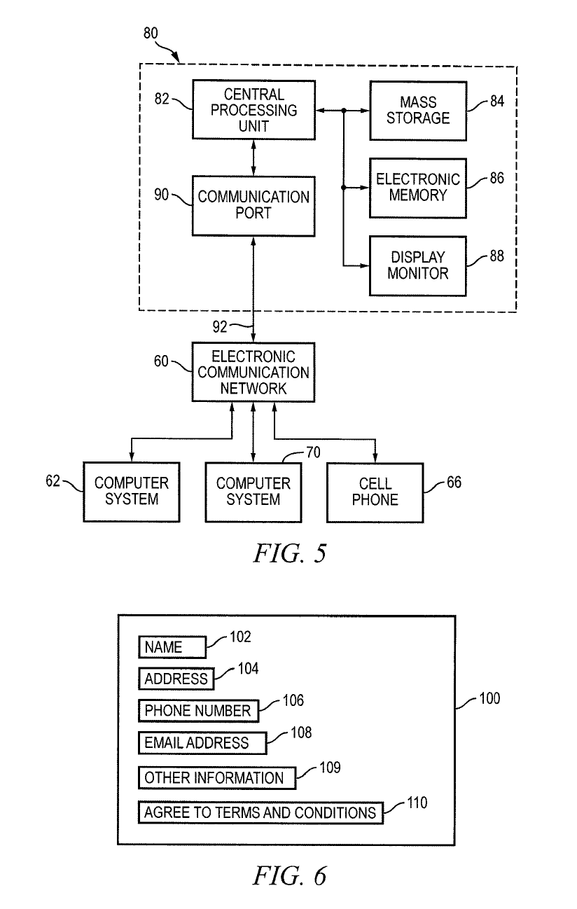

Further detail of the computer systems used in electronic communication network 60 is shown in FIG. 5 as a simplified computer system 80 for executing the software program used in the electronic communication process. Computer system 80 is a general purpose computer including a central processing unit or microprocessor 82, mass storage device or hard disk 84, electronic memory 86, display monitor 88, and communication port 90. Communication port 90 represents a modem, high-speed Ethernet link, wireless, or other electronic connection to transmit and receive input/output (I/O) data over communication link 92 to electronic communication network 60. Computer system or server 62, 70, and 74 can be configured as shown for computer 80. Computer systems 62, 70, 74, and 80 and cellular telephone 66 transmit and receive information and data over communication network 60.

Computer systems 62, 70, 74, and 80 can be physically located in any location with access to a modem or communication link to network 60. For example, computer 62, 70, 74, or 80 can be located in a home or business office. Consumer service provider 52 may use computer system 62, 70, 74, or 80 in its business office. Alternatively, computer 62, 70, 74, and 80 can be mobile and follow the user to any convenient location, e.g., remote offices, consumer locations, hotel rooms, residences, vehicles, public places, or other locales with electronic access to electronic communication network 60. The consumer can access consumer service provider 52 by mobile application operating in cell phone 66.

Each of the computers runs application software and computer programs, which can be used to display user interface screens, execute the functionality, and provide the electronic communication features as described below. An interface can be an individual screen, a collection of websites or screens, a system spread across multiple devices, or a communication medium to submit or receive information. The application software includes an Internet browser, mobile apps, local email application, word processor, spreadsheet, and the like. In one embodiment, the screens and functionality come from the application software, i.e., the electronic communication runs directly on computer systems 62, 70, 74, and 80. Alternatively, the screens and functions are provided remotely from one or more websites on servers within electronic communication network 60.

The software is originally provided on computer readable media, such as compact disks (CDs), external drive, or other mass storage medium. Alternatively, the software is downloaded from electronic links, such as the host or vendor website. The software is installed onto the computer system hard drive 84 and/or electronic memory 86, and is accessed and controlled by the computer operating system. Software updates are also electronically available on mass storage medium or downloadable from the host or vendor website. The software, as provided on the computer readable media or downloaded from electronic links, represents a computer program product containing computer readable program code embodied in a computer program medium. Computers 62, 70, 74, and 80 run application software to execute instructions for communication between consumers 42 and 44 and consumer service provider 52 to generate shopping lists and provide search results for consumers 42 and 44. Cell phone 66 runs one or more mobile apps to execute instructions for communication between consumers 42 and 44 and consumer service provider 52 to generate shopping lists and make recommendations for consumers. The application software is an integral part of the control of commercial activity within commerce system 40.

To interact with consumer service provider 52, consumers 42 and 44 first create an account and profile with the consumer service provider. Consumers 42 and 44 can use some features offered by consumer service provider 52 without creating an account, but full access requires completion of a registration process. The consumer accesses website 100 operated by consumer service provider 52 on computer systems 62, 70, 74, or 80 and provides data to complete the registration and activation process, as shown in FIG. 6. The consumer can access website 100 using cell phone 66 or computer systems 62, 70, 74, or 80 by typing the uniform resource locator (URL) for website 100, or by clicking on a banner located on another website which re-directs the consumer to a predetermined landing page for website 100. The data provided by the consumer to consumer service provider 52 may include name in block 102, home address and work address with zip code in block 104, phone number in block 106, email address in block 108, and other information and credentials in block 109 necessary to establish a profile, identity, and general preferences for the consumer. The consumer's home and work address and zip code are important as shopping is often a local activity. The consumer agrees to the terms and conditions of conducting electronic communication through consumer service provider 52 in block 110.

The profile can also contain information related to the shopping habits and preferences of consumers 42-44. For example, the other information in block 109 includes product preferences, consumer characteristics, and consumer demographics, e.g., gender, age, family size, age of children, occupation, medical conditions, shopping budget, and general product preferences (low fat, high fiber, vegetarian, natural with no preservatives, biodegradable, convenience of preparation or use, name brand, generic brands, kosher). Consumers 42-44 can specify preferred retailers and spending patterns. Alternatively, retailers 46-50 can provide T-LOG data 16 to consumer service provider 52 to accurately track the shopping patterns of consumers 42-44. Consumer service provider 52 will have records of consumer loyalty and value to each retailer. Consumer value is based on spending patterns of the consumer.

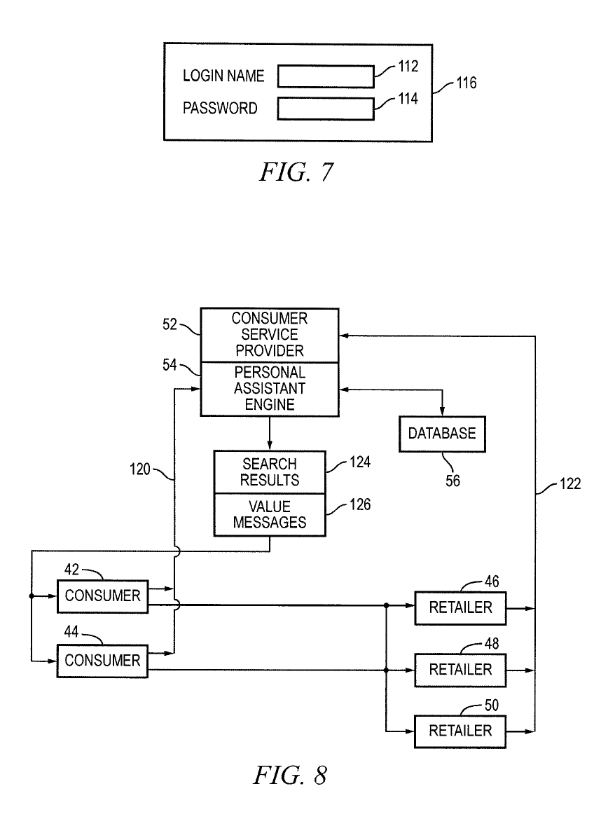

The consumer's profile is stored and maintained within database 56. The consumer can access and update his or her profile or interact by entering login name 112 and password 114 in webpage 116, as shown in FIG. 7. The consumer name can be any personal name, user name, number, or email address that uniquely identifies the consumer and the password can be assigned to or selected by the consumer. Accordingly, the consumer's profile and personal data remain secure and confidential within database 56 by consumer service provider 52.

One feature of personal assistant engine 54 allows the consumer to search for products of interest or need and create a shopping list using the results. FIG. 8 illustrates consumers 42 and 44 in communication with personal assistant engine 54 by electronic link 120. Once logged-in to consumer service provider 52, consumers 42 and 44 can search for products or anticipated purchase products by sending a search criteria to the personal assistant engine 54. Personal assistant engine 54 accesses database 56 and provides consumers 42 and 44 with organic search results 124 and value messages 126. Retailers 46-50 provide value messages 126 to consumer service provider 52 through communication link 122. Retailers 46-50 compete to have value messages 126 displayed with search results by placing bids. Consumer service provider provides organic search results 124 and value messages 126 to consumers 42 and 44 in response to product searches.

In order to store and maintain searchable product lists with relevant products, personal assistant engine 54 must have access to up-to-date, comprehensive, reliable, and objective retailer product information. Consumer service provider 52 maintains database 56 with up-to-date, comprehensive, reliable, and objective retailer product information. The product information includes the product description, product attributes, regular retail pricing, and discounted offers. Consumer service provider 52 must actively and continuously gather up-to-date product information in order to maintain database 56. In one approach to gathering product information, retailers 46-50 may grant access to T-LOG data 16 for use by consumer service provider 52. T-LOG data 16 collected during consumer checkout can be sent electronically from retailers 46-50 to consumer service provider 52, as shown by communication link 122 in FIG. 8. Retailers 46-50 may be reluctant to grant access to T-LOG data 16, particularly without quid pro quo. However, as consumer service provider 52 gains acceptance and consumers 42-44 come to rely on the service to make purchasing decisions, retailers 46-50 will be motivated to participate.

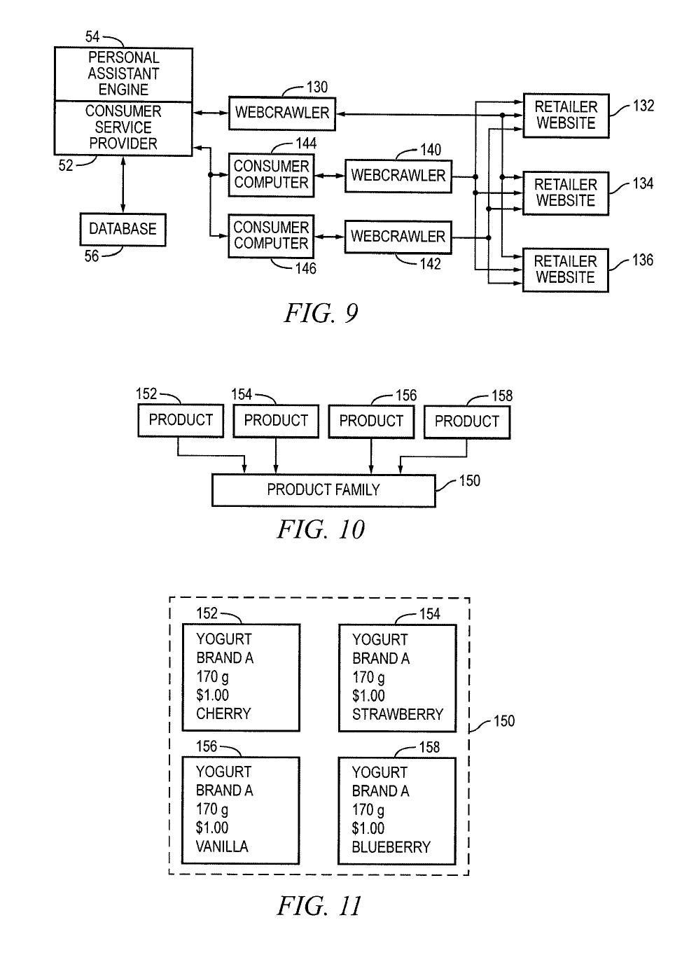

One or more retailers 46-50 may decline to provide access to its T-LOG data for use with personal assistant engine 54. In such cases, consumer service provider 52 can exercise a number of alternative data gathering approaches and sources. In one embodiment, consumer service provider 52 utilizes computer-based webcrawlers or other searching software to access retailer websites for pricing and other product information. In FIG. 9, webcrawler 130 operates within the software of computer systems 62, 70, 74, or 80 used by consumer service provider 52. Consumer service provider 52 dispatches webcrawler 130 to make requests for product information from websites or portals 132, 134, and 136 of retailers 46, 48, and 50, respectively. Webcrawler 130 collects and returns the product information to personal assistant engine 54 for storage within database 56. For example, webcrawler 130 identifies products available from each of retailer websites 132-136 and requests pricing and other product information for each of the identified products. Webcrawler 130 navigates and parses each page of retailer websites 132-136 to locate pricing and other product information. The parsing operation involves identifying and recording product description, universal product code (UPC), price, ingredients, size, and other product information as recovered by webcrawler 130 from retailer websites 132-136. In particular, the parsing operation can identify discounted offers and special pricing from retailers 46-50. The discounted pricing can be used in part to provide up to date pricing information for product search results. The product information from retailer websites 132-136 is sorted and stored in database 56.

Consumer service provider 52 can also dispatch webcrawlers 140 and 142 from computers 144 and 146 used by consumers 42-44, or from consumer cell phone 66, or other electronic communication device, to access and request product information from retailer websites or portals 132-136 or other electronic communication medium or access point. During the registration process of FIG. 6, consumer service provider 52 acquires the IP address of consumer computers 144 and 146, as well as the permission of the consumers to utilize the consumer computer and login to access retailer websites 132-136. Consumer service provider 52 causes webcrawlers 140-142 to be dispatched from consumer computers 144-146 and uses the consumer login to retailer websites 132-136 to access and request product information from retailers 46-50. Webcrawlers 140-142 collect the product information from retailer websites 132-136 through the consumer computer and login and return the product information to personal assistant engine 54 for storage within database 56. The execution of webcrawlers 140-142 from consumer computers 144-146 distributes the computational work.

For example, the consumer logs into the website of consumer service provider 52 via webpage 116. Consumer service provider 52 initiates webcrawler 140 in the background of consumer computer 144 with a sufficiently low execution priority to avoid interfering with other tasks running on the computer. The consumer can also define the time of day and percent or amount of personal computer resources allocated to the webcrawler. The consumer can also define which retailer websites and products, e.g., by specific retailer, market, or geographic region, that can be accessed by the webcrawler using the personal computer resources. Webcrawler 140 executes from consumer computer 144 and uses the consumer's login to gain access to retailer websites 132-136. Alternatively, webcrawler 140 resides permanently on consumer computer 144 and runs periodically. Webcrawler 140 identifies products available from each of retailer websites 132-136 and requests pricing and other product information for each of the identified products. Webcrawler 140 navigates and parses each page of retailer websites 132-136 to locate pricing and other product information. The parsing operation involves identifying and recording product description, UPC, price, ingredients, size, and other product information as recovered by webcrawler 140 from retailer websites 132-136. In particular, the parsing operation can identify discounted offers and special pricing from retailers 46-50. The discounted pricing can be used in part to provide up to date pricing information for product search results. The product information from retailer websites 132-136 is sorted and stored in database 56.

Likewise, webcrawler 142 uses consumer computer 146 and login to gain access to retailer websites 132-136. Webcrawler 142 identifies products available from each of retailer websites 132-136 and requests pricing and other product information for each of the identified products. Webcrawler 142 navigates and parses each page of retailer websites 132-136 to locate pricing and other product information. The parsing operation involves identifying and recording product description, UPC, price, ingredients, size, and other product information as recovered by webcrawler 142 from retailer websites 132-136. In particular, the parsing operation can identify discounted offers and special pricing from retailers 46-50. The discounted pricing can be used in part to provide up to date pricing information for product search results. The product information from retailer websites 132-136 is sorted and stored in database 56. The product information can be specific to the consumer's login. Retailers 46-50 are likely to accept product information requests from webcrawlers 140-142 because the requests originate from consumer computers 144-146 by way of the consumer login to the retailer website.

The product information in database 56 can be organized into product families based on similarity or commonality of brand, price, size, and related product attributes. Given the product information collected by webcrawlers 130, 140, and 142, or the product information provided by retailers 46-50, i.e., T-LOG data 16, or the product information provided by consumers 42-44, consumer service provider 52 organizes the individual products into product families. FIG. 10 shows individual products 152, 154, 156, and 158 organized into product family 150. In one example, product 152 is a yogurt product under brand A with package size of 170 grams (g), price of $1.00, and list of attributes or ingredients that include cherry flavoring, as shown in FIG. 11. Product 154 is a yogurt product under brand A with package size of 170 g, price of $1.00, and list of attributes or ingredients that include strawberry flavoring. Product 156 is a yogurt product under brand A with package size of 170 g, price of $1.00, and list of attributes or ingredients that include vanilla flavoring. Product 158 is a yogurt product under brand A with package size of 170 g, price of $1.00, and list of attributes or ingredients that include blueberry flavoring. Consumer service provider 52 analyzes the product information of products 152-158 and determines that the products differ in the flavoring of the yogurt and otherwise have common product attributes. Consumer service provider 52 groups products 152-158 into product family 150 with common brand, size, price, or related product attribute. Product family 150 is stored in database 56 for each product 152-158.

When accessing products 152-158 for organic search results 124 or value message 126, database 56 can return product family 150 to simplify the presentation of the products in the results list. Consumers can specify product attributes for grouping or searching by setting advanced search parameters. For example, a consumer might select options to group by both brand and size. Although products 152-158 have different UPCs and one or more different product attributes, e.g., different flavoring, products 152-158 are grouped according to one or more similar or common product attributes and presented in organic search results 124 or value messages 126 under the generic product family 150. Organic search results 124 include a single entry for the yogurt product family 150 having the same brand and size attributes instead of individual entries for each flavor of yogurt responsive to the search by consumer 42. Consumer 42 can make quick reference to the yogurt product family 150 while on the premises of retailers 46-50 and can select specific yogurt flavors at that time. Consumer 42 can interpret product family 150 with sufficient understanding to make a purchasing decision for one or more of products 152-158.

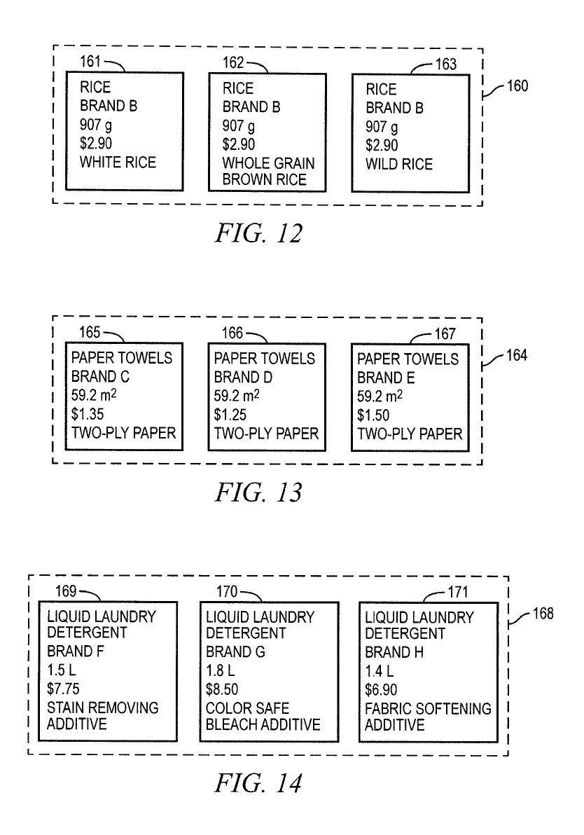

FIG. 12 shows an example of product family 160 containing individual products 161, 162, and 163. Product 161 is a rice product under brand B with package size of 907 g, price of $2.90, and list of attributes or ingredients that include white rice. Product 162 is a rice product under brand B with package size of 907 g, price of $2.90, and list of attributes or ingredients that include whole grain brown rice. Product 163 is a rice product under brand B with package size of 907 g, price of $2.90, and list of attributes or ingredients that include wild rice. Consumer service provider 52 analyzes the product information of products 161-163 and determines that the products differ in the type of rice ingredient and otherwise have common product attributes. Consumer service provider 52 groups products 161-163 into product family 160 with common brand, size, price, or related product attribute. Product family 160 is stored in database 56 for each product 161-163.

When accessing products 161-163 for organic search results 124, database 56 returns product family 160 to simplify the presentation of the products in organic search results 124. Although products 161-163 have different UPCs and one or more different product attributes, e.g., different type of rice, products 161-163 are grouped according to one or more similar or common product attributes and presented in organic search results 124 under the generic product family 160. Organic search results 124 include a single entry for the rice product family 160 instead of individual entries for each type of rice identified by the search requested by consumer 42. Consumer 42 can make quick reference to the rice product family 160 while on the premises of retailers 46-50 and can select specific types of rice at that time. Consumer 42 can interpret product family 160 with sufficient understanding to make a purchasing decision for one or more of products 161-163.

FIG. 13 shows product family 164 containing individual products 165, 166, and 167. Product 165 is a roll of paper towels product under brand C with package size of 59.2 meters² (m²), price of $1.35, and list of attributes that include two-ply paper. Product 166 is a roll of paper towels product under brand D with package size of 59.2 m², price of $1.25, and list of attributes that include two-ply paper. Product 167 is a roll of paper towels product under brand E with package size of 59.2 m², price of $1.50, and list of attributes that include two-ply paper. Consumer service provider 52 analyzes the product information of products 165-167 and determines that the products differ in brand and price and otherwise have common product attributes. Consumer service provider 52 groups products 165-167 into product family 164 with related brands C-E, size, and price range of $1.25-1.50. Product family 164 is stored in database 56 for each product 165-167.

When accessing products 165-167 for organic search results 124, database 56 returns product family 164 to simplify the presentation of the products in search results 124. Although products 165-167 have different UPCs and one or more different product attributes, e.g., different brand and price, products 165-167 are grouped according to one or more similar or common product attributes and presented in organic search results 124 under the generic product family 164. Search results 124 include a single entry for the roll of paper towels product family 164 instead of individual entries for each brand and price identified by consumer 42 for purchase. Consumer 42 can make quick reference to the roll of paper towels product family 164 while on the premises of retailers 46-50 and can select a specific brand and price at that time. Consumer 42 can interpret product family 164 with sufficient understanding to make a purchasing decision for one or more of products 165-167.

FIG. 14 shows product family 168 containing individual products 169, 170, and 171. Product 169 is a liquid laundry detergent product under brand F with package size of 1.5 liters (L), price of $7.75, and list of attributes that include a stain-removing additive. Product 170 is a liquid laundry detergent product under brand G with package size of 1.8 L, price of $8.50, and list of attributes that include a color safe bleach additive. Product 171 is a liquid laundry detergent product under brand H with package size of 1.4 L, price of $6.90, and list of attributes that include a fabric-softening additive. Consumer service provider 52 analyzes the product information of products 169-171 and determines that the products differ in brand, size, price, and type of additive. Consumer service provider 52 groups products 169-171 into product family 168 with related brands F-H, size range of 1.4-1.8 L, price range of $6.90-8.50, and additives of stain removing, color safe bleach, or fabric softening. Product family 168 is stored in database 56 for each product 169-171.

When accessing products 169-171 for organic search results 124, database 56 returns product family 168 to simplify the presentation of the products in search results 124. Although products 169-171 have different UPCs and one or more different product attributes, e.g., different brand, size, price, and type of additive, products 169-171 are grouped according to one or more similar or common product attributes and presented in organic search results 124 or value messages 126 under the generic product family 168. Organic search results 124 include a single entry for the liquid laundry detergent product family 168 instead of individual entries for each type of additive identified by consumer 42 for purchase. Consumer 42 can make quick reference to the liquid laundry detergent product family 168 while on the premises of retailers 46-50 and can select specific brand, size, price, and type of additive at that time. Consumer 42 can interpret product family 168 with sufficient understanding to make a purchasing decision for one or more of products 169-171.

Consumer service provider 52 can group similar or related products into product families with or without the UPC. Consumer service provider 52 accesses database 56 and compares the product information for each individual product to identify similar or common attributes. Products with common attributes are grouped together as a product family related by one or more product attributes, e.g., brand, size, price, ingredient, or additive, and differ by one or more product attributes. When accessing products 169-171 for organic search results 124, database 56 returns the product family 168, which is presented as an entry in search results 124 to simplify and organize multiple related products. Consumer 42 can interpret the product family with sufficient understanding to make a purchasing decision for one or more of the products within the product family.

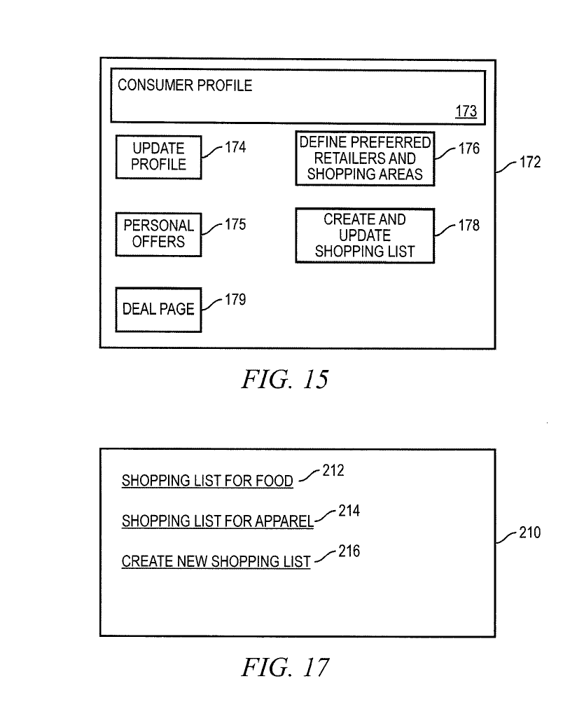

Assume consumer 42 has logged-in to consumer service provider 52 through webpage 116. Consumer 42 is presented with a home page 172, as shown in FIG. 15, to launch a variety of operations and functions using one or more webpages. Block 173 shows the present consumer profile, including name, address, email address, consumer photograph, and other information. The consumer can change personal information and otherwise update the profile in block 174. The consumer can access personal incentives and other offers in block 175. The consumer can define preferred retailers and shopping areas in block 176, search for products, create and update one or more shopping lists in block 178, and access an individualized marketing presentation tool or deal page in block 179.

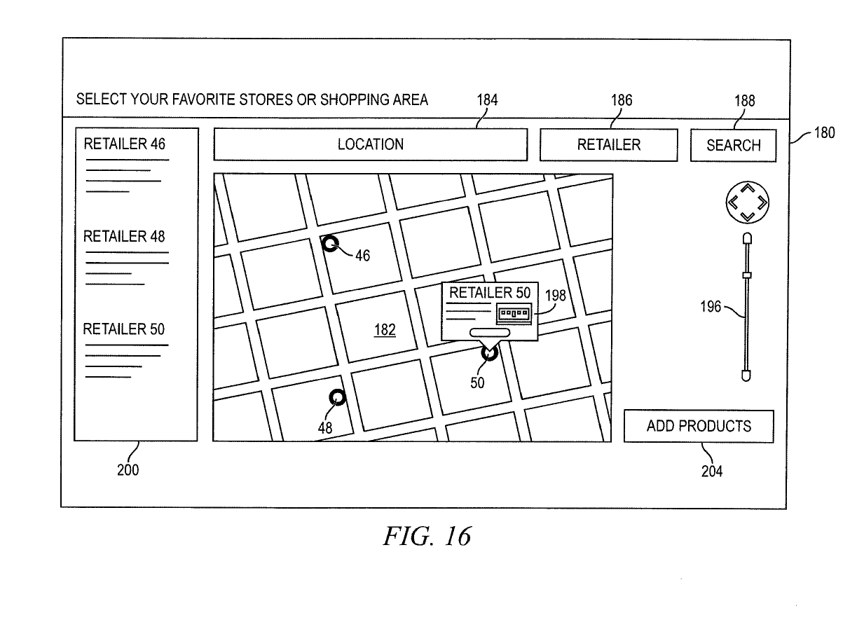

Under the define preferred retailers and shopping areas block 176, personal assistant engine 54 presents webpage 180 with a local map 182, as shown in FIG. 16. A location can be entered in block 184, and retailer name, retailer type, or retailer chain can be entered in block 186. Database 56 contains the name, type, description, and location of retailers nationwide. Consumer 42 presses search button 188 to search database 56 for local retailers according to the location and retailer search pattern in blocks 184-186. The local retailers 46, 48, and 50 matching the search criteria are displayed on map 182. The resolution of map 182 can be adjusted, i.e., zoom in or zoom out, from street level view to a national view with sliding scale 196. Consumer 42 can view additional information about each retailer by hovering the mouse pointer over the retailer location identifier on map 182. For example, pop-up box 198 shows an image, address, phone number, retailer type, retailer website, operating hours, description, and consumer rating and comments of retailer 50. Webpage 180 can provide a button to select all retailers, types of retailers, retailers by tradename, or individual retailers. Consumer 42 searches for grocery retailers and selects retailers 46-50 that he or she would be willing to patronize by individually clicking on the retailer location identifiers 46-50 on map 182. An image, address, phone number, retailer type, retailer website, operating hours, description, and consumer rating and comments of the selected retailers 46-50 are displayed in block 200.

Consumer 42 can also specify all retailers or a selected group of retailers within a geographical shopping area with defined boundaries. The boundaries can be a city, zip code, named roadways, or given number of miles radius to the consumer's address. Consumer 42 can also draw a box on map 182 with the mouse to define the boundaries of the preferred geographical shopping area. The search for retailers would then be limited to the preferred geographical shopping area.

Once the preferred retailers 46-50 or geographical shopping areas are identified, consumer 42 clicks on add products button 204 to create a shopping list of products of interest or need with product attributes weighted by consumer preference. Consumer 42 can also select block 178 in FIG. 15 to create or update a shopping list of products of interest or need with product attributes weighted by consumer preference.

Consumers can create a new shopping list or update an existing shopping list by entering, modifying, or deleting products through one or more webpages, or by mobile app. A plurality of shopping lists can be segregated by type of items, e.g., different shopping lists for food items, household items, apparel, books, and auto parts. A plurality of shopping lists can be segregated by household member, e.g., different shopping lists for each spouse, child, or other member of the household. The shopping list can be aggregated for all items needed by the entire household. In webpage 210 of FIG. 17, personal assistant engine 54 presents link 212 to an existing shopping list for food items and link 214 to an existing shopping list for apparel, as well as link 216 to create a new shopping list. Consumer 42 selects a link to add, delete, or modify the shopping list.

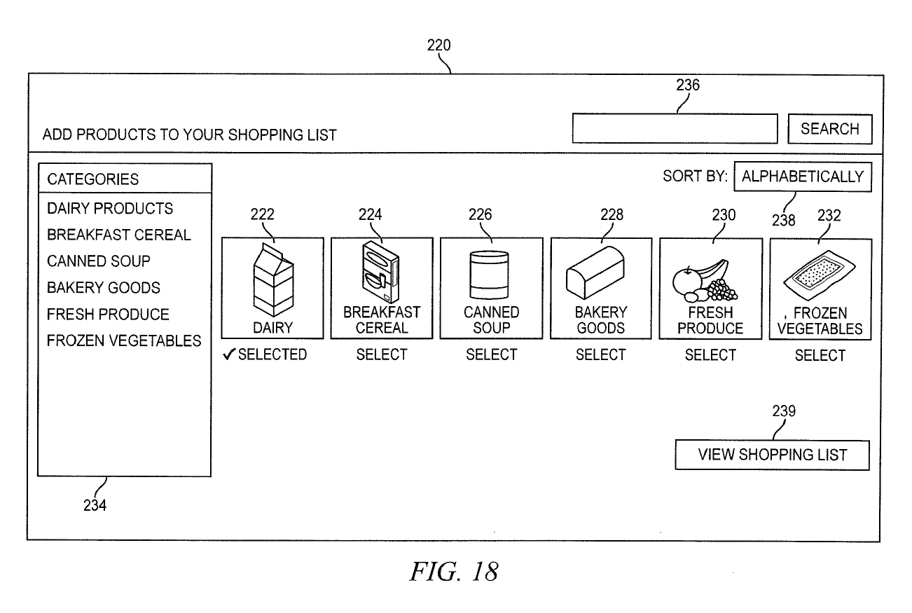

As an illustration of links 212-216, FIG. 18 shows webpage 220 presenting categories of food items. A category is presented for each type of food item. For example, block 222 with corresponding select button is presented for dairy products or dairy product family (DP), block 224 with corresponding select button is presented for breakfast cereal or breakfast cereal family (BC), block 226 with corresponding select button is presented for canned soup or canned soup family (CS), block 228 with corresponding select button is presented for bakery goods or bakery goods family (BG), block 230 with corresponding select button is presented for fresh produce or fresh produce family (FP), and block 232 with corresponding select button is presented for frozen vegetables or frozen vegetables family (FV). A list of categories of food items is also presented in block 234. Block 236 with adjacent search button enables consumer 42 to search for other categories or specific food items. Block 238 enables consumer 42 to sort the categories of food by cost, frequency of purchase, alphabetically, or other convenient attribute.

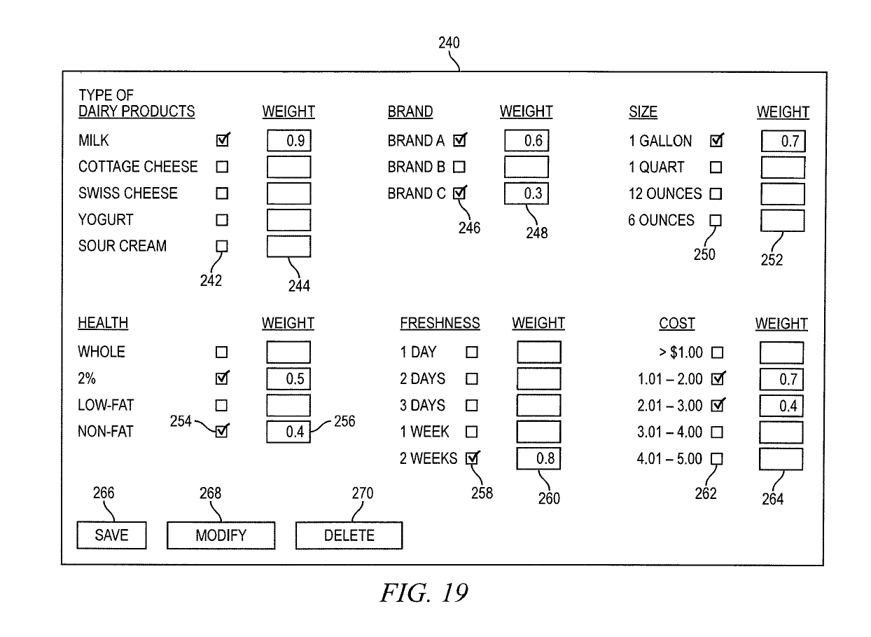

Consumer 42 clicks on the select button corresponding to a category of food item. In the present example, consumer 42 clicks the select button for block 222 to choose attributes and weighting factors or preference levels for dairy products or dairy products family. The available attributes for dairy products or dairy products family are presented in a pop-up window on webpage 220 or on a different webpage. FIG. 19 shows pop-up window 240 overlaying webpage 220 with attributes for type of dairy product, brand, size, health, freshness, and cost. Each attribute has an associated consumer-defined weighting factor for relative importance to the consumer. For example, the attributes for type of dairy product include milk, cottage cheese, Swiss cheese, yogurt, and sour cream. Consumer 42 can select one or more attributes under the type of dairy product by clicking on boxes 242. A checkmark appears in the box 242 selected by consumer 42. Consumer 42 can enter a weighting value or indicator in block 244 corresponding to the importance of the selected attribute. The weighting factor can be a numeric value, e.g., from 0.0 (lowest importance) to 0.9 (highest importance), “always”, “never”, or other designator meaningful to the consumer. Alternatively, block 244 includes a sliding scale to select a relative value for the weighting factor. The sliding scale adjusts the preference level of the product attribute by moving a pointer along the length of the sliding scale. The computer interface can be color coded or otherwise highlighted to assist with assigning a preference level for the product attribute. In the present pop-up window 240, consumer selects milk under type of dairy product and assigns a weighting factor of 0.9. Consumer 42 considers milk to be an important type of dairy product to be added to the shopping list.

In pop-up window 240, the attributes for brand include brand A, brand B, and brand C. A brand option is provided for each type of dairy product or for the selected type of dairy product. Consumer 42 can select one or more attributes under brand by clicking on boxes 246. A checkmark appears in the box 246 selected by consumer 42. Consumer 42 can enter a weighting value or indicator in block 248 corresponding to the importance of the selected attribute. The weighting factor can be a numeric value, e.g., 0.0-0.9. Alternatively, block 248 includes a sliding scale to select a relative value for the weighting factor. In the present pop-up window 240, consumer selects brand A with a weighting factor of 0.6 and brand C with a weighting factor of 0.3 for the selected milk attribute. Consumer 42 considers either brand A or brand C to be acceptable, but brand A is preferred over brand C as indicated by the relative weighting factors. The weighting factors associated with different brands allow consumer 42 to assign preference levels to acceptable brand substitutes.

The attributes for size include one-gallon, 1 quart, 12 ounces, and 6 ounces. A size option is provided for each type of dairy product or for the selected type of dairy product. Consumer 42 can select one or more attributes under size by clicking on boxes 250. A checkmark appears in the box 250 selected by consumer 42. Consumer 42 can enter a weighting value or indicator in block 252 corresponding to the importance of the selected attribute. The weighting factor can be a numeric value, e.g., 0.0-0.9. In the present pop-up window 240, consumer selects one-gallon with a weighting factor of 0.7 for the selected milk attribute.

The attributes for health include whole, 2%, low-fat, and non-fat. A health option is provided for each type of dairy product or for the selected type of dairy product. Consumer 42 can select one or more attributes under health by clicking on boxes 254. A checkmark appears in the box 254 selected by consumer 42. Consumer 42 can enter a weighting value or indicator in block 256 corresponding to the importance of the selected attribute. The weighting factor can be a numeric value, e.g., 0.0-0.9. In the present pop-up window 240, consumer selects 2% with a weighting factor of 0.5 and non-fat with a weighting factor of 0.4 for the selected milk attribute. Consumer 42 considers either 2% milk or non-fat milk to be acceptable, but 2% milk is preferred over non-fat as indicated by the relative weighting factors. The weighting factors associated with different health attributes allow consumer 42 to assign preference levels to acceptable health attribute substitutes.

The attributes for freshness include 1-day-old, 2 days old, 3 days old, 1 week to expiration, or 2 weeks to expiration. A freshness option is provided for each type of dairy product or for the selected type of dairy product. Consumer 42 can select one or more attributes under freshness by clicking on boxes 258. A checkmark appears in the box 258 selected by consumer 42. Consumer 42 can enter a weighting value or indicator in block 260 corresponding to the importance of the selected attribute. The weighting factor can be a numeric value, e.g., 0.0-0.9. In the present pop-up window 240, consumer selects 2 weeks to expiration with a weighting factor of 0.8 for the selected milk attribute.

The attributes for cost include less than $1.00, $1.01-2.00, $2.01-3.00, $3.01-4.00, or $4.01-5.00. Consumer 42 can select one or more attributes under cost by clicking on boxes 262. A checkmark appears in the box 262 selected by consumer 42. Consumer 42 can enter a weighting value or indicator in block 264 corresponding to the importance of the selected attribute. The weighting factor can be a numeric value, e.g., 0.0-0.9. In the present pop-up window 240, consumer selects $1.01-2.00 with a weighting factor of 0.7 and $2.01-3.00 with a weighting factor of 0.4 for the selected milk attribute. Consumer 42 is willing to pay either $1.01-2.00 or $2.01-3.00, but would prefer to pay $1.01-2.00 as indicated by the relative weighting factors.

Once the consumer-defined attributes and weighting factors for milk are selected, consumer 42 clicks on save button 266 to record the configuration in database 56. The consumer-defined attributes and weighting factors for milk can be modified with modify button 268 or deleted with delete button 270 in pop-up window 240.

Consumer 42 can add, delete, or modify additional types of dairy products, such as cottage cheese, Swiss cheese, yogurt, and sour cream, in a similar manner as described for milk in FIG. 19. For each type of dairy product, consumer 42 selects one or more brand attributes and associated weighting factors, size attributes and weighting factors, health attributes and weighting factors, freshness attributes and weighting factors, and cost attributes and weighting factors. For each type of dairy product, consumer 42 clicks on save button 266 to record the weighted attribute configuration in database 56. Consumer 42 can also click on modify button 268 or delete button 270 to change or cancel a previously entered product configuration.

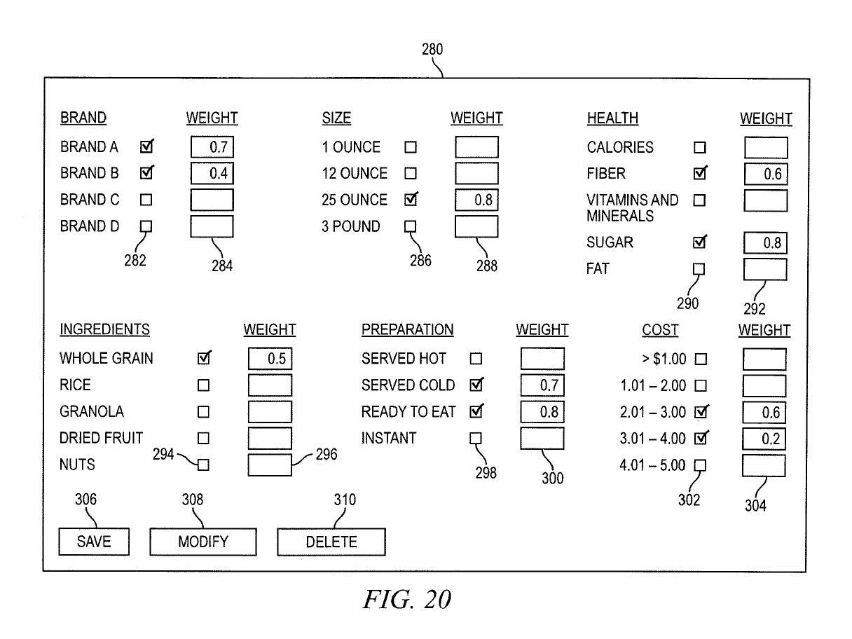

Once the attributes and weighting factors for all dairy products are defined by consumer preference, consumer 42 returns to FIG. 18 to make selections for the next product category. In the present example, consumer 42 clicks the select button for block 224 to choose attributes and weighting factors for breakfast cereal or breakfast cereal family. The available attributes for breakfast cereal products are presented in a pop-up window on webpage 220 or on a different webpage. FIG. 20 shows pop-up window 280 overlaying webpage 220 with attributes for brand, size, health, ingredients, preparation, and cost. Each attribute has an associated consumer-defined weighting factor for relative importance to the consumer. For example, the attributes for brand include brand A, brand B, brand C, and brand D. Consumer 42 can select one or more attributes under brand by clicking on boxes 282. A checkmark appears in the box 282 as selected by consumer 42. Consumer 42 can enter a weighting value or indicator in block 284 corresponding to the importance of the selected attribute. The weighting factor can be a numeric value, e.g., from 0.0 (lowest importance) to 0.9 (highest importance), “always”, “never”, or other designator meaningful to the consumer. Alternatively, block 284 includes a sliding scale to select a relative value for the weighting factor. The sliding scale adjusts the preference level of the product attribute by moving a pointer along the length of the sliding scale. The computer interface can be color coded or otherwise highlighted to assist with assigning a preference level for the product attribute. In the present pop-up window 280, consumer selects brand A with a weighting factor of 0.7 and brand B with a weighting factor of 0.4 for the selected brand attribute. Consumer 42 considers either brand A or brand B to be acceptable, but brand A is preferred over brand B as indicated by the relative weighting factors. The weighting factors associated with different brands allow consumer 42 to assign preference levels to acceptable brand substitutes.

The attributes for size include 1 ounce, 12 ounce, 25 ounce, and 3 pound. Consumer 42 can select one or more attributes under size by clicking on boxes 286. A checkmark appears in the box 286 selected by consumer 42. Consumer 42 can enter a weighting value or indicator in block 288 corresponding to the importance of the selected attribute. The weighting factor can be a numeric value, e.g., 0.0-0.9. In the present pop-up window 280, consumer selects 25 ounce size with a weighting factor of 0.8.

The attributes for health include calories, fiber, vitamins and minerals, sugar content, and fat content. Health attributes can be given in numeric ranges. Consumer 42 can select one or more attributes under health by clicking on boxes 290. A checkmark appears in the box 290 selected by consumer 42. Consumer 42 can enter a weighting value or indicator in block 292 corresponding to the importance of the selected attribute. The weighting factor can be a numeric value, e.g., 0.0-0.9. In the present pop-up window 280, consumer selects fiber with a weighting factor of 0.6 and sugar content with a weighting factor of 0.8. Consumer 42 considers fiber and sugar content with numeric ranges to be important nutritional attributes according to the relative weighting factors.

The attributes for ingredients include whole grain, rice, granola, dried fruit, and nuts. Consumer 42 can select one or more attributes under ingredients by clicking on boxes 294. A checkmark appears in the box 294 selected by consumer 42. Consumer 42 can enter a weighting value or indicator in block 296 corresponding to the importance of the selected attribute. The weighting factor can be a numeric value, e.g., 0.0-0.9. In the present pop-up window 280, consumer selects whole grain with a weighting factor of 0.5.

The attributes for preparation include served hot, served cold, ready-to-eat, and instant. Consumer 42 can select one or more attributes under preparation by clicking on boxes 298. A checkmark appears in the box 298 selected by consumer 42. Consumer 42 can enter a weighting value or indicator in block 300 corresponding to the importance of the selected attribute. The weighting factor can be a numeric value, e.g., 0.0-0.9. In the present pop-up window 280, consumer selects served cold with a weighting factor of 0.7 and ready-to-eat with a weighting factor of 0.8.

The attributes for cost include less than $1.00, $1.01-2.00, $2.01-3.00, $3.01-4.00, or $4.01-5.00. Consumer 42 can select one or more attributes under cost by clicking on boxes 302. A checkmark appears in the box 302 selected by consumer 42. Consumer 42 can enter a weighting value or indicator in block 304 corresponding to the importance of the selected attribute. The weighting factor can be a numeric value, e.g., 0.0-0.9. In the present pop-up window 280, consumer selects $2.01-3.00 with a weighting factor of 0.6 and $3.01-4.00 with a weighting factor of 0.2. Consumer 42 is willing to pay either $2.01-3.00 or $3.01-4.00, but would prefer to pay $2.01-3.00 as indicated by the relative weighting factors.

Once the consumer-defined attributes and weighting factors for breakfast cereal are selected, consumer 42 clicks on save button 306 to record the configuration in database 56. The consumer-defined attributes and weighting factors for breakfast cereal can be modified with modify button 308 or deleted with delete button 310 in pop-up window 280.

Consumer 42 can add, delete, or modify other breakfast cereals in a similar manner as described in FIG. 20. For each breakfast cereal, consumer 42 selects one or more brand attributes and associated weighting factors, size attributes and weighting factors, health attributes and weighting factors, ingredients attributes and weighting factors, preparation attributes and weighting factors, and cost attributes and weighting factors. For each breakfast cereal, consumer 42 clicks on save button 306 to record the weighted attribute configuration in database 56. Consumer 42 can also click on modify button 308 or delete button 310 to change or cancel a previously entered product configuration.

Consumer 42 makes selections of attributes and weighting factors canned soup or canned soup family in block 226, bakery goods or bakery goods family in block 228, fresh produce or fresh produce family in block 230, and frozen vegetables or frozen vegetables family in block 232, as well as other food categories, in a similar manner as described in FIGS. 19 and 20. The food categories can also be selected from block 234 in FIG. 18. The consumer-defined product attributes and weighting factors for each food category are stored in database 56. The attributes and weighting factors as selected by consumer 42 in each of the food categories constitute an initial or generally defined list of products of interest or need by the consumer.

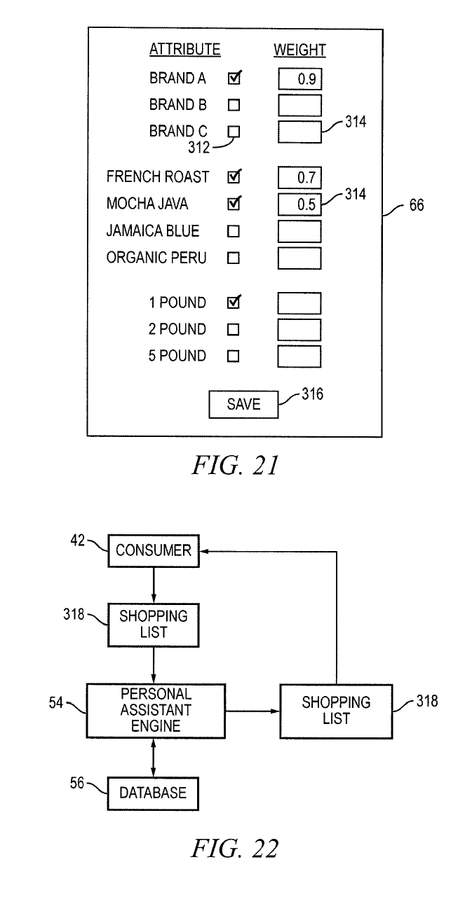

In another embodiment, consumer 42 can record product attributes and weighting factors by mobile app. When patronizing a retailer, consumer 42 can record a product of interest or need by scanning the UPC on the shelf or product itself with cell phone 66. The UPC is transmitted to consumer service provider 52 and decoded. The product attributes are retrieved from database 56, transmitted back to consumer 42, and displayed on cell phone 66. For example, if consumer 42 scans a particular ground coffee, the UPC identifies the product as brand A, French roast flavor, and 1 pound size for the ground coffee, as shown in FIG. 21. Personal assistant engine 54 provides other ground coffee attributes, e.g., other brands, flavors, and sizes. Consumer 42 can select product attributes by clicking on boxes 312, i.e., to indicate a willingness to consider similar products, and assign weighting factors for the product attributes in boxes 314. Consumer 42 selects brand A and assigns a weighting factor. Consumer 42 also checks the attributes to accept French roast and mocha Java flavors with corresponding weighting factors. No weight is assigned to the size attribute. The product attributes and weighting factors are transmitted back to consumer service provider 52 and stored in database 56 to update the consumer's profile by clicking on save button 316. The mobile app on cell phone 66 can also decode the UPC.

In FIG. 22, personal assistant engine 54 stores shopping list 318 with weighted product attributes of each specific consumer in database 56 for future reference and updating. Personal assistant engine 54 can also store prices, product descriptions, names and locations of the retail stores selling the products, offer histories, purchase histories, as well as various rules, policies and algorithms. The individual products in the shopping list can be added or deleted and the weighted product attributes can be changed by the consumer. The shopping list entered into personal assistant engine 54 is specific for each consumer and allows consumer service provider 52 to track specific products and preferred retailers selected by the consumer.

The consumer can also identify a specific preferred retailer as an attribute with an assigned preference level based on convenience and personal experience. The consumer may assign value to shopping with a specific retailer because of specific products offered by that store, familiarity with the store layout, good consumer service experiences, or location that is convenient on the way home from work, picking up the children from school, or routine weekend errand route.

Using the consumer-generated shopping list 318 as defined in FIGS. 18-21, personal assistant engine 54 has detailed information regarding the consumer that enables personal assistant engine 54 to create a precise shopping profile for the consumer. The precise shopping profile can be used to direct value messages to consumers, divide consumers into market segments, or provide the most relevant search results.

Occasionally, consumer 42 wants to locate a particular product of interest or a type of product to add to shopping list 318, consider for purchase, or gather information. Consumer 42 searches for products and receives results including information about products of interest. To conduct a search, consumer 42 chooses a search criteria expected to correspond with the desired results and enters the criteria into a search field in a computer application or website. Consumer 42 sends the search criteria to a search engine, where the criteria is processed and used to locate responsive results. The search engine processes the results into the desired format and returns the results to consumer 42. Consumer 42 reviews organic search results 124 and selects the desired member of the result set for further use, such as adding to shopping list 318 or considering for purchase. For example, consumer 42 is trying to learn about healthy diet options for regulating carbohydrate intake. Consumer 42 enters the search criteria “wheat bread” into a search field on a personal computer in order to learn more about wheat bread and consider wheat bread products for purchase. Consumer 42 presses the search button and sends the search criteria to a search engine. The search engine processes the criteria to compile a set of search results 124 for the term wheat bread including members D wheat bread, B wheat bread, and A wheat bread. The search engine processes search results 124 to the desired format for consumer 42, alphabetizing the results. The search engine then returns the result set including A wheat bread, B wheat bread, and D wheat bread to consumer 42 in alphabetical order. Consumer 42 views search results 124 and selects A wheat bread to add to shopping list 318.

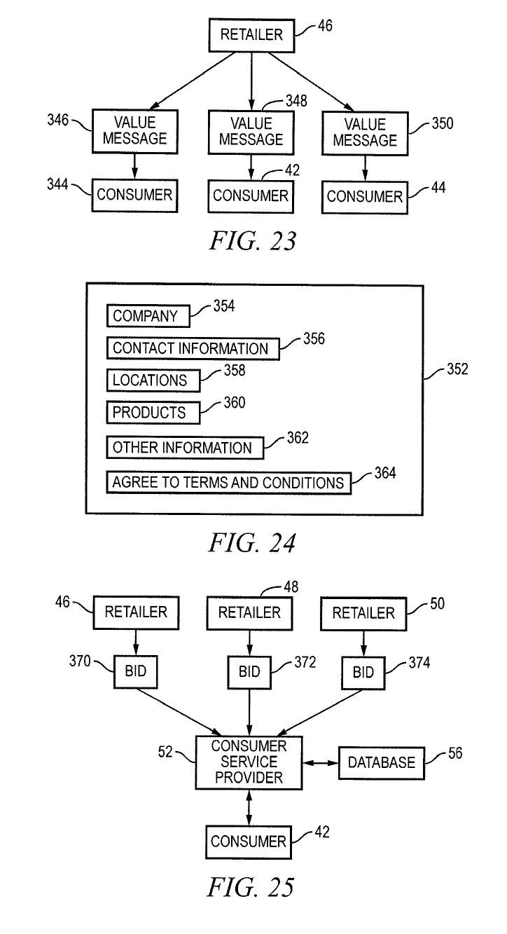

Retailers 46-50 present products to consumer 42 to entice positive purchasing decisions. Retailers 46-50 enhance organic search results 124 by presenting additional products that are likely to interest consumer 42. One way retailer 46 presents products to consumers 42, 44, and 344 is through value messages 346, 348, and 350, as shown in FIG. 23. Value messages 346-350 can include a combination of images, text, audio, or video to create the perception of value for consumers 42, 44, and 344. Retailers 46-50 craft value messages to identify important product features, introduce new product lines, highlight product attributes, compare competing products, or make consumers 42, 44, and 344 aware of a product.

For example, retailer 46 selling organic foods competes with retailers 48 and 50 to sell produce to consumers 42, 44, and 344. Retailers 48 and 50 grow inorganic produce using pesticides, genetically engineered seed, and synthetic fertilizers. Retailer 46 grows organic produce using unaltered seed, manure fertilizer, and pesticide free farming techniques. Produce from retailer 46 is more expensive, reflecting the higher production costs associated with organic farming, but offers value to consumers that prefer organic foods, such as consumer 42. Unfortunately, consumer 42 is unaware that produce offered by retailer 46 is organically grown. Retailer 46 presents produce to consumers 42, 44, and 344 with the value message “fresh and natural, grown without pesticides.” The value message highlights a feature of the produce from retailer 46 that is particularly valuable to consumer 42, i.e., the produce is pesticide free. After viewing the value message consumer 42, who now knows that retailer 46 offers organic produce, makes a positive purchasing decision for produce from retailer 46.

Product presentations are more effective when consumer 42 is interested in purchasing a presented product. Retailers 46-50 present value messages 346-350 to consumers 42, 44, and 344 through consumer service provider 52 with organic search results 124 to reach interested consumers 42, 44, and 344. Before submitting value messages to consumer service provider 52, retailers 46-50 create an account and profile with consumer service provider 52. Retailer 46 accesses website 352 operated by consumer service provider 52 and provides data to complete the registration and activation process, as shown in FIG. 24. The retailer can access website 352 using cell phone 66 or computer systems 62, 70, 74, or 80 by typing the uniform resource locator (URL) for website 352, or by clicking on a banner located on another website which re-directs the consumer to a predetermined landing page for website 352. The data provided by the consumer to consumer service provider 52 can include the company name in block 354. Contact information block 356 can include a contact address with zip code, phone number, and email address. Locations are submitted in block 358. Products or product categories offered by retailer 46 are entered in block 360. Other information and credentials necessary to establish a profile, identity, and product portfolio for retailer 46 are submitted in block 362. The retailer's locations and zip code are important as shopping is often a local activity. The retailer agrees to the terms and conditions of conducting electronic communication through consumer service provider 52 in block 364.

The retailer's profile is stored and maintained within database 56. The retailer can access and update the profile or interact by entering login name 112 and password 114 in webpage 116, as shown in FIG. 7. The retailer name can be any company name, user name, number, or email address that uniquely identifies the retailer and the password can be assigned to or selected by the retailer. Accordingly, the retailer's profile and sensitive data remain secure and confidential within database 56.

When consumer 42 submits a search query, consumer service provider 52 retrieves value messages 346-350 and corresponding content from database 56 to send to consumer 42. Consumer service provider 52 limits the number of value messages 346-350 displayed so that the value messages 346-350 and search results 124 are easily digested and useful to consumer 42. Consumer service provider 52 selects which value messages 346-350 to display with each set of search results 124. For example, retailer 46 is a dish soap vendor that submits the value message “kills 99.9% of germs and bacteria” to consumer service provider 52 for display with search results for dish soap. Consumer service provider stores the value message in database 56. Consumer 42 submits a search to consumer service provider 52 with the search criteria dish soap. Consumer service provider 52 parses the criteria and accesses organic search results for dish soap. Consumer service provider also retrieves value messages for the search criteria dish soap from database 56, including the message “kills 99.9% of germs and bacteria.” Consumer service provider 52 processes the organic search results, selects which value messages to include, and returns organic search results 124 with selected value messages 346-350 to consumer 42. Consumer 42 reviews the search results and value message from retailer 46.

One way consumer service provider 52 selects which of value messages 346-350 to display is through a bidding system, as shown in FIG. 25. Retailers 46-50 submit bids 370, 372, and 374 to include value messages 346-350 with search results 124 provided to consumers 42, 44, and 344. Retailers 46-50 decide how much to bid using a marginal value analysis using the likelihood of a positive purchasing decision to project the ideal bid amount. Bids 370-374 represent the amount retailers 46-50 are willing to pay when a consumer selects a product presented in a value message or consumer service provider 52 includes the value message with search results 124. Consumer service provider 52 processes and stores bids 370-374 in database 56. Consumer 42 submits a search query to consumer service provider 52 containing search criteria. Consumer service provider 52 parses the search criteria and determines which bids 370-374 are eligible to display for the search criteria. Consumer service provider 52 then compares the eligible bids to determine which are the highest. Consumer service provider 52 selects the desired number of value messages by choosing the value messages eligible for display for the search criteria that also have the highest bids. Consumer 42 receives the selected value messages and search results from consumer service provider 52 containing products that consumer 42 can add to shopping list 318, consider for purchase, or research.

For example, retailer 46 submits bid 370 offering $0.10 to display value message 346 for Brand X Paper Towels when a consumer searches for paper towels. Retailer 48 submits bid 372 offering $0.11 to display value message 348 for Brand Y Paper Towels when a consumer searches for paper towels. Retailer 50 submits bid 374 offering $0.09 to display value message 350 for Brand Z Paper Towels when a consumer searches for paper towels. Consumer 42 submits a search query with the search criteria paper towels to consumer service provider 52. Consumer service provider 52 finds eligible value messages 346-350 and corresponding bids 370-374 in database 56 based on the criteria paper towels. Consumer service provider 52 finds value messages 346-350 from retailers 46-50 that are eligible to display for the search on paper towels. Consumer service provider 52 compares bid amounts associated with eligible value messages 346-350 and determines that bid 372 of $0.11 is the highest eligible bid on paper towels. Bid 372 corresponds to value message 348 for Brand Y Paper Towels so consumer service provider 52 selects value message 348 for display along with the search results 124 and returns value message 348 with search results 124 to consumer 42. Consumer 42 reviews search results 124 as well as value message 348 for desired product information. Competing retailer 46 can have value message 346 for Brand X Paper Towels displayed with future searches if retailer 46 submits a new bid that is higher than bid 372 from retailer 48.

Consumer service provider can also select value messages 346-350 to display for consumer 42 by selecting a most valuable bid based on criteria in addition to or separate from the bidding system. One alternative criteria is retailer reputation with consumers. Consumer service provider 52 can improve consumer perception of consumer service provider 52 by presenting value messages from retailers 46 that are popular with consumer 42. Using T-LOG data, consumer service provider has information enabling the presentation of value messages from popular retailers to consumers on an individual consumer basis. Consumer service provider 52 can also provide consumer 42 with value messages from products that consumer 42 is most likely to purchase based on historical behavior. Presenting to historically interested consumer 42 with value message 346 enhances the value of the message for both consumer service provider 52 and retailer 46. Consumer service provider 52 can convert the historical data into a likelihood that consumer 42 will purchase a product presented in a value message, represented as a conversion rate. A conversion rate is a number representing a number of purchases divided by the number of presentations. Consumer service provider can multiply a bid by the conversion rate to determine a weighted bid product and select the value message having the highest weighted bid product. Consumer service provider 52 may also select value messages by choosing retailer 46 offering the most valuable long-term partnership. Introducing retailer 46 to the value message system in a positive manner can be more valuable to consumer service provider 52 long term than selecting the message with the highest bid amount for display. Consumer service provider 52 weighs the value of retailer 46 as a client and then compares bids 370-374 giving additional weight to bids from valuable retailer partners.

Bids 370-374 from retailers 46-50 can become active immediately, at a predetermined update time, or after expiration of a fixed period following the bid. In one embodiment, consumer service provider 52 activates high bids immediately. For example, on Sunday, Brand Y is a high bidder offering $0.11 to display value message 348 for Brand Y Paper Towels when a consumer searches for paper towels. On Monday, Company Z submits bid 374 offering $0.12 to display value message 350 for Company Z Paper Towels when a consumer searches for paper towels. Bid 374 from Company Z is active immediately and is the highest bid for a consumer search on paper towels. Consumer 42 submits the search criteria paper towels to consumer service provider 52 on Wednesday. Consumer service provider 52 selects value message 350 for Company Z Paper Towels to display with search results 124. Different waiting periods can be implemented to give former high bidders such as Brand Y the opportunity to submit an increased bid and maintain the high bidder position.

For example, consumer service provider 52 activates bids 72 hours after bid submission. Brand Y is the active high bidder on Sunday with bid 372, offering $0.11 to display value message 348 for Brand Y Paper Towels when a consumer searches for paper towels. On Monday, Company Z submits bid 374 offering $0.12 to display value message 350 for Company Z Paper Towels when a consumer searches for paper towels. Bid 374 from Company Z is the highest bid for a consumer search on paper towels at $0.12 but is subject to a 72-hour waiting period before becoming active. Consumer 42 searches for paper towels on Wednesday, before bid 374 from Company Z becomes active. Bid 372 from Company Y is still the highest active bid when consumer 42 submits the search for paper towels because 72 hours have not passed since bid 374 was submitted by Company Z. Value message 348 for Brand Y Paper Towels is displayed to consumer 42 with organic search results 124.

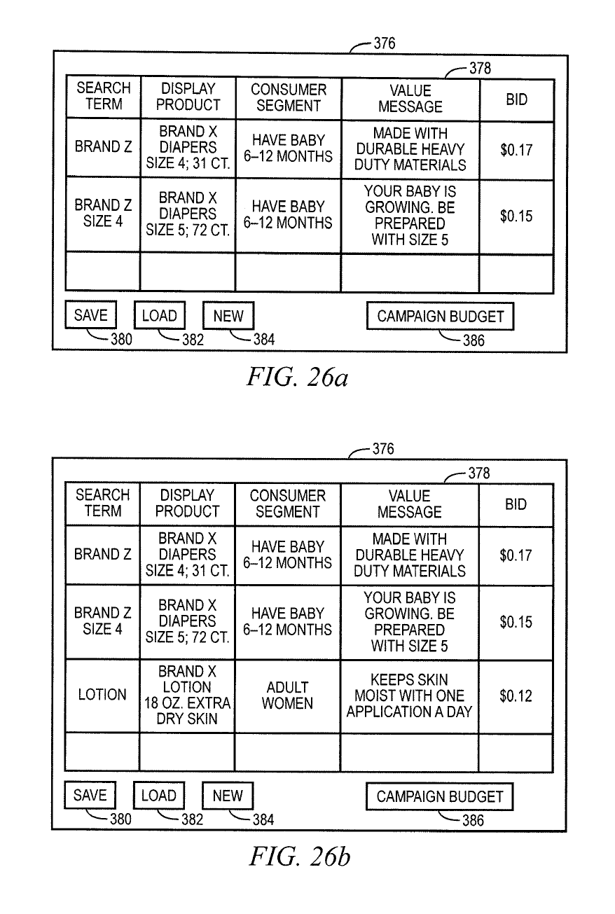

Retailers 46-50 can submit value messages through interface 376 by filling out a campaign table 378, as shown in FIGS. 26a and 26b. FIG. 26a shows campaign table 378 containing value message submissions contained in the two rows of bid information entered by retailer 46. The value message submissions stored as rows in campaign table 378 can be submitted at one time or in parts. For example, retailer 42 submits a value message submission to consumer service provider containing an entry in the bid field. The bid information can be processed by consumer service provider absent further information populating the other fields of the value message submission. To access interface 376, retailer 46 logs in through webpage 116. Retailer 46 starts a campaign by entering value message information into rows of the campaign table. Retailer 46 enters a consumer search criteria into the search term field. When consumer 42 submits the search criteria matching the search criteria the corresponding value message is selected and evaluated for display to consumer 42. In the display product field, retailer 46 enters the desired product to display with a value message, if any. The product field is populated with a UPC code, a product family, or a product. Retailer 46 enters the market segment that the value message targets in the consumer segment field. Retailer 46 enters a text, audio, or video message into the value message field for display to consumers. In the bid field, retailer 46 enters the currency amount, revenue percentage, or sale percentage that retailer is willing to pay when a consumer selects the display product for purchase. Retailers offering an affiliate program or other percentage based payment plan can enter the affiliate information in the bid field. Once retailer 46 has entered the desired bids into campaign table 378, retailer 46 can submit campaign table 378 to consumer service provider 52 by pressing save button 380. Retailer 46 can load a saved campaign table by pressing load button 382 and selecting the desired campaign table. A new campaign table is created by pressing new button 384. A campaign budget can be entered into campaign budget field 386 to place a maximum budget on the marketing campaign. Any bids in the campaign become inactive once the campaign budget is expended.

For example, in FIG. 26a retailer 46 logs in to a profile through website 116 and presses new button 384 to create a new campaign table 378. Retailer 46 enters Brand Z into the search term field for the first value message. The display product is Brand X diapers in size 4 packaged with 31 diapers to the box. Retailer 46 targets the market segment of consumers that have a baby 6-12 months old. The value message field is populated with a text value message that states “made with durable heavy duty materials.” Retailer 46 bids $0.17 in the first row in the campaign table. Retailer 46 then makes a second bid by entering a second row into the campaign table. In the second row, Retailer 46 enters a new search term, Brand Z size 4. The display product field is populated with the product Brand X diapers in size 5 packaged in a 72 count. Brand X targets the same market segment of consumers that have a baby 6-12 months old. Retailer 46 enters the text “Your baby is growing. Be prepared with size 5.” Retailer 46 bids $0.15 on the second row in the campaign table. Retailer 46 submits the table to consumer service provider 52 by pressing save button 380. Consumer service provider 52 saves the campaign information in database 56. Retailer 46 later wants to add an additional bid to the campaign table.

Brand X again logs in to the profile through website 116 and retrieves campaign table 378 by pressing load button 382 and selecting campaign table 378. In FIG. 26b, retailer 46 adds another row corresponding to the new bid. The search term is lotion. The display product is Brand X Lotion for extra dry skin packaged in 18-ounce dispensers. The bid is for the market segment of adult women. The value message submitted in the campaign table is “keeps skin moist with one application a day.” Retailer 46 enters a bid of $0.12 for the third row in the campaign table. Brand X submits the updated campaign table to consumer service provider 52 by pressing save button 380.

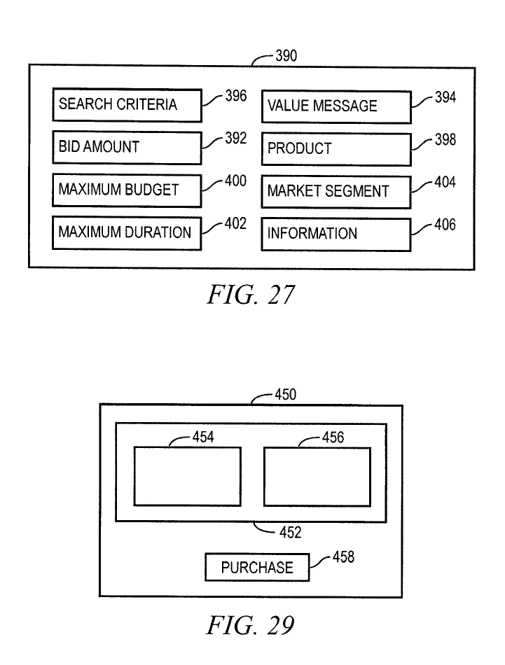

Retailers 46-50 can also use interface 390 of FIG. 27 to interact with consumer service provider 52 and submit details for bids 370-374 and campaign tables, as shown in FIG. 25. Interface 390 contains a bid amount field 392 for retailers 46-50 to enter a bid amount. In value message field 394, retailers 46-50 enter the text, video, or image content to display to consumer 42. Value message block 394 can be populated with special offers to augment value messages. Special offers are presented to consumer 42 based on the search criteria submitted to consumer service provider 52. Consumer 42 can purchase the special offer through consumer service provider by pressing a purchase button contained in value message 346. For example, retailer 46 sells milk and enters a special offer of “One gallon milk variety of your choice, delivered to your door weekly for one year at a 50% discount.” Consumer searches for milk and is presented with the message from retailer 46. Consumer 42 can accept the offer by pressing a purchase button accompanying the value message to enter the transaction. Special offers can contain unique terms such as delivery for one year, lifetime supply, or other incentives that increase product value for the consumer. When consumer 42 presses a purchase button the transaction is completed using login name 112 and password 114 as shown in FIG. 7. Consumer 42 is prompted to log in or create an account if consumer 42 is not logged in. Once consumer 42 creates an account or logs in, consumer can elect to purchase special offers made by retailers 46-50 without the need to provide additional log in information to retailers 46-50.

Retailers 46-50 enter a search criteria into the search criteria field 396 by either typing a search criteria into the field or selecting a search criteria from a list provided by consumer service provider 52. Consumer service provider 52 can suggest search criteria grouped into categories or individually. Retailers 46-50 can enter search criteria by selecting individual criteria or categories of search criteria from the list. For example, retailer 46 wants to bid to display a value message for a milk product but is uncertain what search criteria to enter into search criteria field 396. Retailer 46 browses a list of criteria from consumer service provider 52 and selects the category dairy products to narrow the list of criteria to the group of search criteria related to dairy products. Retailer 46 enters the category of dairy product related terms into search criteria block 396. The criteria group selected by retailer 46 matches a multitude of consumer search criteria including yogurt, milk, cheese, cream, and other dairy products. Retailer 46 can also bid to display a value message for all consumer searches by not limiting the bid to specific search criteria.

Product field 398 of interface 390 allows retailers to select a product or product family for display in a value message. A product consists of an image, a price, a name, and other product information. Consumer service provider 52 can provide a list of products for retailer 46 to choose from including products that retailer 46 has displayed in the past or products offered by retailer 46 based on T-LOG data. Retailer 46 selects a product or product family for display with the value message. When consumer 42 views the value message, consumer 42 can add the product to a shopping list by pressing an add button corresponding to the product.

Interface 390 contains maximum budget field 400 and duration 402 to limit the life of a bid or campaign. Retailers 46-50 can limit the life of a bid by entering a currency amount into maximum budget field 400 or a time period into maximum duration field 402. The bid becomes inactive or expires when the maximum budget has been used or the bid duration has passed. A bid duration or maximum budget can apply to individual bids, collections of bids, or entire campaigns. For example, retailer 46 submits a bid of $0.25, a maximum budget of $100, and a duration of one week to display value message 346 with the search criteria shorts. Consumers submit several searches for shorts to consumer service provider 52 over the first five days that the bid is active. Value message 346 is displayed to consumers often and is selected by consumers 400 times during the five-day period, resulting in the $0.25 bid amount being charged 400 times for a total of $100. The maximum budget is expended on the fifth day when consumer 42 selects value message 346 for the 400th time. The bid becomes inactive for future searches until the maximum budget is increased or a new bid is submitted. The one-week duration on the bid does not limit the life of a bid unless time expires before reaching the maximum budget for the bid. For example, retailer 46 submits the same bid of $0.25, a maximum budget of $100, and a duration of one week to display value message 346 with the search term shorts. The weather has cooled down and consumers submit fewer searches for shorts. At the end of the seventh day, consumers have selected shorts from value message 346 only 100 times for a total of $25. The bid becomes inactive at the end of seven days when the duration expires.

Bids can also expire a set time in the future. Consumer service provider 52 can accept bids on a search term until a specified date and time. At the specified date and time, the auction ends and the highest bid wins a set amount of time where the corresponding value messages will be displayed with search results. Consumer service provider fixes bid duration field 402 to the predetermined bid duration. For example, consumer service provider 52 offers search criteria in one-week increments, with the winning bids calculated every Friday at 5:00 pm. The retailer that submits the winning bid on Friday has a value message position guaranteed until the following Friday at 5:00 pm when bids are re-evaluated. on Wednesday, retailer 46 submits a high bid of $0.15 for value message 346 to be displayed with the search criteria hair spray. Retailer 46 is identified as the high bidder on Friday at 5:00 pm. Retailer 48 submits new high bid of $0.020 on Sunday to display value message 348 with the search criteria hair spray. Consumer 42 submits a search on Monday with the search criteria hair spray. Value message 346 is returned to consumer 42 because retailer 46 remains the highest bid until Friday at 5:00 pm, when the bid from retailer 48 becomes the high bid. Consumer 44 submits a search on Friday at 5:01 pm for the search criteria hair spray. Value message 348 is returned to consumer 44 because retailer 48 became the high bidder on 5:00 pm.

Market segment field 404 enables retailer to specify specific groups of consumers to receive the value message 346. When consumer 42 is logged in to consumer service provider 52 through webpage 116, the information stored in the consumer profile can be used to identify the market segments containing consumer 42. Market segments are identified based on attributes such as retailer preferences, consumer characteristics, and consumer demographics, e.g., gender, age, family size, age of children, occupation, medical conditions, shopping budget, marital status, geographic location. Market segments are also identified by general product preferences such as low fat, high fiber, vegetarian, natural with no preservatives, biodegradable, convenience of preparation or use, name brand, generic brands, kosher. Retailers 46-50 can use market segments to match value messages to consumers that are likely to make a positive purchasing decision when presented with a certain product attribute or characteristic. For example, retailer 46 selling vegetables to consumer 42 that values freshness can use value message 346 displaying “produce delivered fresh daily.” The same retailer 46 selling vegetables to consumer 44 that values organic foods can use value message 348 displaying “pesticide free vegetables.” Retailers 46-50 can also target all consumers with a value message if market segmentation is not desired.

For example, retailer 46 enters the market segment of males over 25 years old into market segment block 404 and submits the highest bid to display value message 346 with the search criteria red car. Consumer 42 is a 30-year-old male that submits the search criteria red car to consumer service provider 52. Consumer 42 receives search results and value messages for the search criteria red car, including value message 346 submitted by retailer 46. Consumer 44 is a 30-year-old female that submits the search criteria red car to consumer service provider 52. Consumer 44 is not a member of the market segment of males over 25. Consumer 44 receives search results and value messages for the search criteria red car, however the value messages do not include value message 346 submitted by retailer 46. Continuing from the example above, retailer 46 targets all consumers in market segment block 404 and submits a new high bid to display value message 346 with the search criteria red car. Consumer 44 submits the search criteria red car to consumer service provider 52 and receives search results and value messages for the search criteria red car. The value messages presented to consumer 44 now include value message 346 submitted by retailer 46 targeting the all consumers.

Consumer service provider 52 provides retailer 46 with bid information and statistics through information block 406. Information block 406 contains status of active bids including whether retailer 46 has been outbid recently. Information block 406 contains a history of bids and value messages for retailer 46. The history includes past and projected performance information on value messages submitted by retailer 46 including how often value messages have been displayed, the number of consumers that selected the product presented in value messages, and the number of times the value message was eligible for display but did not have a corresponding high bid. Information block 406 also displays bid information for the bids that are currently active including whether the bid is a high bid and the incurred cost associated with the bid to date. Information block 406 also contains statistical information on search criteria entered by retailer 46 such as the quantity of bids on search criteria, the current high bid amounts on search criteria, the frequency a search criteria is submitted by consumers, and the average rate at which consumers select products displayed with a search criteria. Information block can also be delivered to retailers 46-50 through email messaging and presented in a manner similar to interface 390.

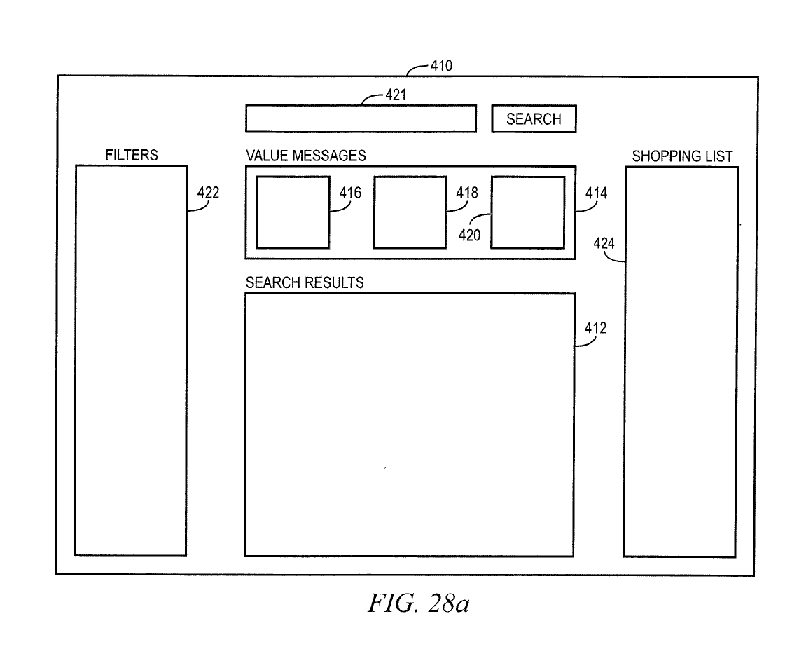

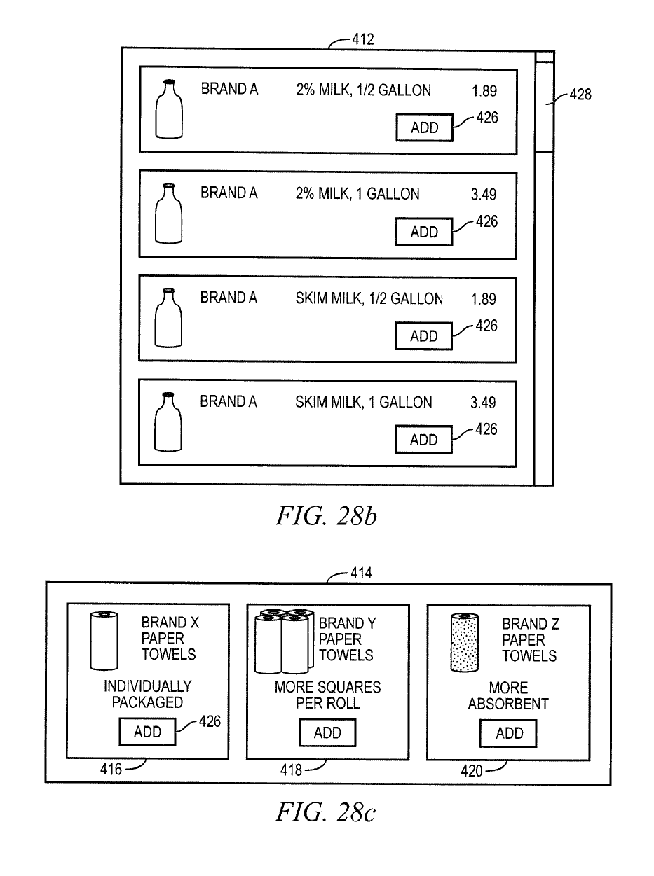

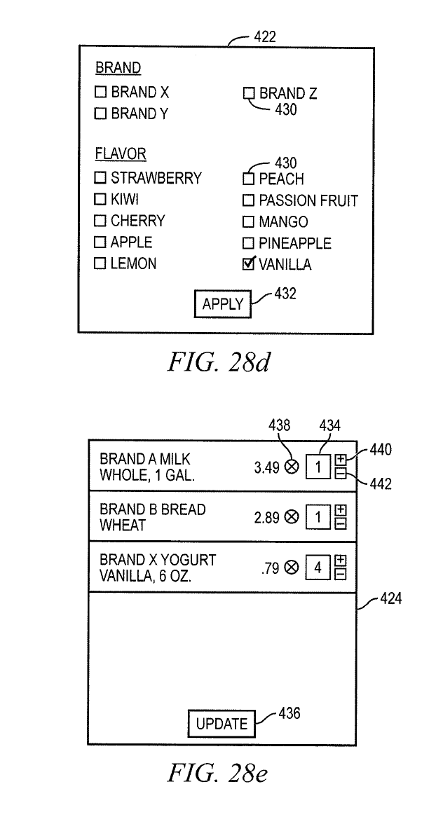

Consumer 42 views interface 410 to review search results 412 and value messages 414, shown in FIG. 28. Search results block 412 and value message block 414 display information based on a search query submitted by consumer 42. Value message block contains value message space in three positions 416-420. Consumer 42 submits a search query to consumer service provider 52 using search field 421 on interface 410 or a similar search field in another interface or website. Consumer service provider 52 receives the search query and parses the search query to access database 56. Consumer service provider 52 retrieves search results 412 from database 56 based on the search query. Consumer service provider 52 compiles search results 412 by selecting relevant product information obtained from T-LOG data, webcrawlers, or submitted by retailers or consumers. Relevant product information is identified by comparing the search query to product information stored in database 56. Product matches are identified when the search query matches a product attribute, product name, or other product information based on the selected comparison algorithm. Consumer service provider 52 uses a comparison algorithm where the search query will match a product if search criteria appears in an attribute field for the product such as name, manufacturer, flavor, color, size, or quantity. Other comparison algorithms can be used to detect product matches.

For example, consumer 42 submits a search query to consumer service provider 52 consisting of the search term milk. Consumer service provider 52 accesses database 56 to compare product attributes to the search term milk. Matching products are identified based on the term milk appearing in a product attribute. Matching products identified based on the term milk appearing in the ingredients attribute include whole milk, skim milk, yogurt, cheese, and chocolate bars. Matching products identified based on the term milk appearing in the name attribute include whole milk, skim milk, 2% milk, chocolate milk, milk of magnesia, and milk chocolate. Products from several different companies match the same search criteria. Matching products are processed and sorted into the desired format for presentation to consumer 42. Processing can include grouping matching products into product families, ordering products based on weighting attributes identified in consumer profile, sorting based on popularity, or sorting products according to product attributes such as price, size, color, quantity, or name. The organic search results are displayed in interface 410 in search results block 412 of interface 410. In FIG. 28b, a set of organic search results for the search term milk is processed into alphabetical order. The search results contain whole, skim, and 2% milk from Brand A, Brand B, and Brand C. Search results block 412 contains a scroll bar 428 to view organic search results when the number of search results exceeds the space available on one screen. The organic search results for milk exceed the space available on one screen so that only a few of the search results are displayed at a given time. Search results block 412 shows Brand A 2% and skim milk products in half-gallon and one-gallon varieties with scroll bar 428 positioned at the top search result block 412 so the first search results are showing. By moving the scroll bar 428 downward, consumer 42 can view the remaining search results including whole milk from Brand A and 2%, skim, and whole milk products from Brand B and Brand C. Consumer 42 adds products to shopping list by pressing the corresponding add button 426.

Value message block 414 includes value messages located in positions 416, 418, and 420. Consumer service provider can increase or decrease the number of value messages displayed in the value message block by increasing or decreasing the number of positions 416-420 in value message block 414. Value messages 346-350 occupy positions 416-420 in value message block 414 based on bid value so that the most valuable bid corresponds to the most desirable position. The value message in first position 416 has the most valuable bid and occupies the left end of value message block 414. The value message in second position 418 has the second most valuable bid and occupies the center of value message block 414. The value message in third position 420 has the third most valuable bid and occupies the right side of value message block 414. Retailers 46-50 having value messages placed in second position, third position, or are not among the top bidders can move into first position 416 by submitting the most valuable bid. When high-bidding retailer 46 is outbid by a competitor, consumer service provider 52 sends a notification to retailer 46 stating that retailer 46 has been outbid. Retailer 46 can submit an increased bid to recover high-bidder status and place a value message in first position.

For example, in FIG. 28c retailer 46 submits bid 370 offering $0.15 to display the value message “individually packaged” for Brand X Paper Towels when a consumer searches for paper towels. Retailer 48 submits bid 372 offering $0.11 to display the value message “more squares per roll” for Brand Y Paper Towels when a consumer searches for paper towels. Retailer 50 submits bid 374 offering $0.09 to display the value message “more absorbent” for Brand Z Paper Towels when a consumer searches for paper towels. Bids 370-374 are the three highest bids on the search term paper towels. Consumer 42 submits a search query with the search criteria paper towels to consumer service provider 52. Consumer service provider 52 retrieves search results 124, matching value messages 346-350, and bids 370-374 corresponding to value messages 346-350. Consumer service provider 52 assigns positions to value messages based on bid amounts. Retailer 46 has the highest bid 370 so consumer service provider 52 assigns the Brand X value message to first position 416. Retailer 48 has the second-highest bid 372 so consumer service provider 52 assigns the Brand Y value message to second position 418. Retailer 50 has the third-highest bid 374 so consumer service provider 52 assigns the Brand Z value message to third position 420. Consumer service provider 52 returns value messages in positions 416-420 to consumer 42 for display in value message block 414 of interface 410. Value message block 414 is displayed for consumer 42 with value messages 346-350 appearing in order so that Brand X Paper Towels is in first position 416, Brand Y Paper Towels is in second position 418, and Brand Z Paper Towels is in third position 420. Consumer 42 adds Brand X Paper Towels to shopping list 318 by pressing add button 426 in the Brand X value message.

Interface 410 also contains search filters 430 in filters block 422, as shown in FIG. 28d. Search filters can be used by consumer 42 to refine a search by hiding products that have less value to consumer 42. Search filters 430 can hide products based on size, flavor, price, color, quantity, product family, brand, or other product attributes. Consumer 42 activates a search filter by locating the desired filter in filters block 422. Consumer 42 checks the corresponding box, selects the filter from a dropdown menu, or selects the filter using an add filter button and applies the desired search filters 430 by pressing apply button 432. Selected search filters 430 are transmitted to consumer service provider 52 to process search results 124 and value messages 346-350. During the processing, the filters are applied to search results 124 and value messages 346-350 that consumer service provider 52 provided in response to the search query submitted by consumer 42. Consumer service provider 52 applies search filters by including only products that match the search filter in search results and value messages for display. After the filters are applied, consumer 42 views only the products matching the search filter through search results block 412 and value message block 414.

For example, consumer 42 enters the term brand X yogurt into the search field 421 to try to locate vanilla yogurt in a 6 oz. size. Consumer service provider 52 returns search results containing Brand X yogurt in strawberry, cherry, vanilla, kiwi, apple, peach, passion fruit, mango, pineapple, and lemon varieties each coming several sizes including individual 6 oz. cups, 6 oz. cups in four packs, and individual 2 pound cups. The three value messages from Brand Y are the value messages with the highest bids that also match the search criteria yogurt. Consumer service provider returns relevant value messages along with search results 124, including a message for the product family containing individually packaged 6 oz. yogurt from Brand Y, 2 pound strawberry yogurt cups from Brand Y, and Brand Y vanilla yogurt four packs of 6 oz. cups. Consumer 42 initially views search results 124 and value messages but finds the results are over inclusive. Consumer 42 selects the search filter based on flavor that displays only vanilla yogurt products by clicking the box corresponding to the vanilla flavor filter 430. Consumer 42 applies the filter by pressing apply button 432. The search results displayed are then limited to Brand X vanilla yogurt in the individual 6 oz. cup, Brand X vanilla yogurt in four packs of 6 oz. cups, and Brand X vanilla yogurt in a 2 pound cup. All yogurt varieties without a vanilla yogurt attribute are hidden, i.e., strawberry, cherry, kiwi, apple, peach, passion fruit, mango, pineapple, and lemon flavor varieties. Product groups that contain at least one member with the search filter flavor attribute vanilla are not hidden. When the search filter for vanilla yogurt is applied to the value messages, the value message for 2 pound cups of strawberry yogurt from Brand Y is hidden. The value messages for Brand Y vanilla yogurt in four packs of 6 oz. cups and for Brand Y product family of individually packaged 6 oz. yogurt are shown. Consumer service provider 52 retrieves another value message from database 56 and fills the position in value message block 414 left vacant after hiding the value message for Brand Y strawberry yogurt in 2 pound cups. Consumer 42 can select products from the displayed search results 412 and value messages 414 to add to a shopping list.

Interface 410 displays an active shopping list in shopping list block 424, shown in FIG. 28e. The active shopping list can include products added by consumer 42, a list of products generated by consumer service provider 52, a previously saved list, or a new list with no products added. Consumer 42 selects different shopping lists for display in block 424 by clicking on links 212, 214, or 216 corresponding to the desired list, as shown in FIG. 17. Products displayed in search results 412 or value messages 414 are added to the active shopping list by pressing add button 426 for the desired product. The desired quantity of a product on the shopping list can be increased or decreased by entering a number in a quantity field 434 and pressing update button 436. Consumer 42 removes a product from the shopping list by pressing remove button 438 for the product or reducing the quantity of the product to zero in quantity field 434 and pressing update button 436. Quantity can also be adjusted incrementally by pressing increase button 440 or decrease button 442. As consumer 42 adds, removes, or changes the quantity of products in shopping list block 424 consumer service provider 52 saves the updated shopping list in database 56.

In addition to using interface 410 in FIG. 28, consumer 42 views value messages and special offers through interface 450 as shown in FIG. 29. Interface 450 can be a pop-up window, a website, a banner, or another graphical user interface for presentation to consumer 42. Interface 450 contains value message 452 presenting product 454 and special offer 456 to consumer 42. In block 454, value message 452 contains product information and a text, video, or audio message to consumer 42. The information in block 454 is chosen to create value in the mind of consumer 452. Value message 450 contains a special offer in block 456. Special offer 456 is a product or service offer to consumer 42 containing a special discount, a special duration offer, or other beneficial terms to increase the value of a deal to consumer 42. Consumer 42 can take advantage of special offer by clicking purchase button 458. For example, retailer 46 sells meat and enters a special offer of “5 pounds of your choice of meat, delivered to your door weekly for one year at a 50% discount.” Consumer can accept the offer by pressing a purchase button built into the value message and completing the transaction. When consumer 42 selects purchase button 458 the transaction is completed using login name 112 and password 114 as shown in FIG. 7. Consumer 42 is prompted to log in or create an account if consumer 42 is not logged in. Once consumer 42 creates an account or logs in, consumer can elect to purchase special offers made by retailers 46-50 without the need to provide additional log in information to retailers 46-50. Consumer 42 effectively has access to several ecommerce sites with one login. Consumer service provider 52 controls the commerce system by presenting value message 450 to consumer 42, 44, 344 to create the perception of value and entice positive purchasing decisions.

In the business transactions between consumers 42-44 and retailers 46-50, consumer service provider 52 plays an important role in terms of increasing sales for the retailer while providing the consumer with the most value for the money, i.e., creating a win-win scenario. More specifically, consumer service provider 52 presents products to captive customers highlighting product features most likely to establish value in the minds of the consumers.

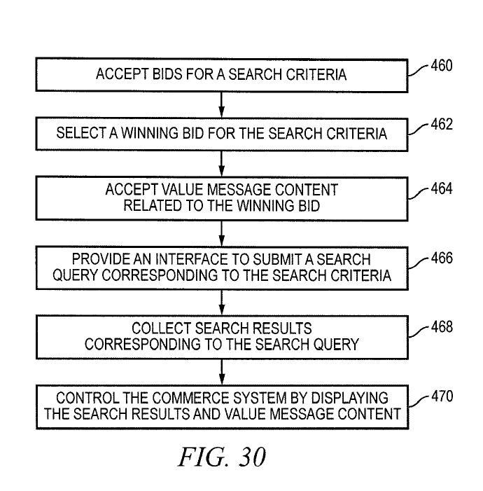

FIG. 30 illustrates a process for controlling a commerce system by enabling the consumer to identify products for purchasing from the retailer. In step 460, a plurality of bids for a search criteria are collected. In step 462, a winning bid for the search criteria is selected from the plurality of bids. In step 464, value message content related to the winning bid for the search criteria is accepted. In step 466, an interface to submit a search query corresponding to the search criteria is provided. In step 468, search results corresponding to the search query are collected. In step 470, the commerce system is controlled by displaying the search results and value message content to influence purchasing decisions.

In summary, the consumer service provider in part controls the movement of goods between members of the commerce system. Retailers offer products for sale. Consumers make decisions to purchase the products. Consumer service provider 52 offers consumers product search and identification services to aid the consumer in making purchasing decisions. In particular, consumer service provider 52 collects product information associated with a plurality of products. Consumer service provider 52 can receive the product information from a retailer in the form of transactional data or data retrieved from a retailer website. Consumer service provider 52 presents products of interest to the consumer on a search results page based on a search query submitted by the consumer. The results page presents search results and value messages to the consumer. Consumer service provider selects value messages for display by finding the value messages with the most valuable bids. The value messages convey product features or benefits that increase the value to a searching consumer. The consumer selects one or more products of interest from the search results page. Consumer service provider 52 generates a shopping list including one or more of the products of interest. The shopping list includes the consumer-selected products and is available to a consumer to assist with purchasing decisions. The shopping list helps the consumer to make the purchasing decision based on comprehensive, reliable, and objective retailer product information, as well as an individualized value message highlighting important product attributes. The consumer makes purchases within the commerce system based on the search results, value messages, and product information compiled by the consumer service provider. By evaluating the search results and value messages from the consumer service provider, the consumer can consider a variety of products and receive the most value for the money. The consumer service provider becomes the preferred source of retail information for the consumer, i.e., an aggregator of retailers capable of providing one-stop shopping.

While one or more embodiments of the present invention have been illustrated in detail, the skilled artisan will appreciate that modifications and adaptations to those embodiments may be made without departing from the scope of the present invention as set forth in the following claims.

What is claimed:

1. A method of controlling a commerce system, comprising:
accepting a plurality of bids for a search criteria;
selecting a winning bid for the search criteria from the plurality of bids;
accepting value message content related to the winning bid for the search criteria;
providing an interface to submit a search query corresponding to the search criteria;
collecting search results corresponding to the search query; and
controlling the commerce system by displaying the search results and value message content to influence purchasing decisions.

2. The method of claim 1, further including applying a market segment to a scope of the bids.

3. The method of claim 1, further including accepting the search criteria with the bids.

4. The method of claim 1, further including selecting the winning bid based on a value of the bids.

5. The method of claim 1, further including:
providing a database containing product information; and
collecting the search results corresponding to the search query from the database.

6. A method of controlling a commerce system, comprising:
accepting a plurality of bids for a search criteria;
selecting a winning bid for the search criteria from the plurality of bids;
accepting value message content related to the winning bid for the search criteria;
receiving a search query corresponding to the search criteria; and
displaying the value message content.

7. The method of claim 6, further including:
providing a database containing product information;
collecting search results corresponding to the search query from the database; and
displaying the search results.

8. The method of claim 6, further including providing an interface to submit the plurality of bids for the search criteria.

9. The method of claim 6, further including applying a market segment to a scope of the bids.

10. The method of claim 6, further including accepting the search criteria with the bids.

11. The method of claim 6, further including selecting the winning bid based on a value of the bids.

12. The method of claim 6, further including providing a shopping list including products selected from the value message content.

13. A method of controlling a commerce system, comprising:
accepting a bid for a search criteria;
receiving a search query corresponding to the search criteria; and
displaying content related to the bid for the search criteria.

14. The method of claim 13, further including:
collecting search results corresponding to the search query; and
displaying the search results with the content.

15. The method of claim 13, further including:
providing a database containing product information; and
collecting search results corresponding to the search query from the database.

16. The method of claim 13, further including applying a market segment to a scope of the bid.

17. The method of claim 13, further including accepting the search criteria with the bid.

18. The method of claim 13, further including providing an interface to submit the bid for the search criteria.

19. The method of claim 13, further including displaying content related to the bid for the search criteria including an offer.

20. A computer program product usable with a programmable computer processor having a computer readable program code embodied in a non-transitory computer usable medium for controlling a commerce system, comprising:
accepting a bid for a search criteria;
receiving a search query corresponding to the search criteria; and
displaying content related to the bid for the search criteria.

21. The computer program product of claim 20, further including:
collecting search results corresponding to the search query; and
displaying the search results and the content.

22. The computer program product of claim 20, further including:
providing a database containing product information; and
collecting search results corresponding to the search query from the database.

23. The computer program product of claim 20, further including applying a market segment to a scope of the bid.

24. The computer program product of claim 20, further including accepting the search criteria with the bid.

25. The computer program product of claim 20, further including providing an interface to submit the bid for the search criteria.
